(19) United States
(12) Patent Application Publication
(10) Pub. No.: US 2025/0284562 A1
(43) Pub. Date: Sep. 11, 2025

(54) GIBBS SAMPLING METHODS USING THERMODYNAMIC COMPUTING

(71) Applicant: Extropic Corp., Austin, TX (US)

(72) Inventors: Christopher Chamberland, Austin, TX (US); Guillaume Verdon-Akzam, San Francisco, CA (US)

(73) Assignee: Extropic Corp., Austin, TX (US)

(21) Appl. No.: 19/068,922

(22) Filed: Mar. 3, 2025

Related U.S. Application Data
(60) Provisional application No. 63/562,566, filed on Mar. 7, 2024.

(51) Int. Cl. G06F 9/50; G06N 5/04

(52) U.S. Cl. CPC G06F 9/5094; G06N 5/04

(57) ABSTRACT

Systems, methods and computer readable media relating to neuro-thermodynamic computers configured to implement hierarchical architecture, wherein the hierarchical architecture includes one or more layers of components, and wherein the hierarchical architecture is configured to perform Gibbs sampling and nested Gibbs sampling. For example, a block layer may include an energy based model (EBM) implemented using oscillators and couplings between oscillators. A chip layer may include multiple blocks coupled to each other using relay oscillators. A package layer may include multiple chips coupled to each other using additional relay oscillators.

### RELATED APPLICATION

This application claims benefit of priority to U.S. Provisional Application Ser. No. 63/562,566, entitled “Gibbs Sampling Methods Using Thermodynamic Computing,” filed Mar. 7, 2024, and which is incorporated herein by reference in its entirety.

### BACKGROUND

### Description of Related Art

Various algorithms, such as machine learning algorithms, often use statistical probabilities to make decisions or to model systems. Some such learning algorithms may use Bayesian statistics, or may use other statistical models that have a theoretical basis in natural phenomena. Also, machine learning algorithms themselves may be implemented using Bayesian statistics, or may use other statistical models that have a theoretical basis in natural phenomena.

Generating such statistical probabilities may involve performing complex calculations which may require both time and energy to perform, thus increasing a latency of execution of the algorithm and/or negatively impacting energy efficiency. In some scenarios, calculation of such statistical probabilities using classical computing devices may result in non-trivial increases in execution time of algorithms and/or energy usage to execute such algorithms.

### BRIEF DESCRIPTION OF THE DRAWINGS

FIG. 1 illustrates a hierarchical thermodynamic computing architecture made using energy based model (EBM) blocks, wherein Gibbs sampling may be performed using relay oscillators representing inputs and latent variables, according to some embodiments.

FIG. 2A illustrates an energy based model (EBM) used to compute a conditional probability distribution with inputs and outputs as thermodynamic data, according to some embodiments.

FIG. 2B illustrates an example energy based model (EBM) of a block of a hierarchical thermodynamic computing architecture that is partially dynamical (PD), wherein oscillators of the EBM implement neurons while synapses of the EBM are encoded in hardware, according to some embodiments.

FIG. 3 illustrates an example energy based model (EBM) of a block of a hierarchical thermodynamic computing architecture that is fully dynamical (FD), wherein oscillators implement neurons and synapses of the EBM block, according to some embodiments.

FIG. 4 illustrates an analogue-digit implementation of a chip component, comprising two partially dynamical (PD) block components and a relay oscillator, wherein a degree of freedom of an output neuron of a PD block is measured, a relay oscillator is clamped to the measured value, then the relay oscillator is coupled to an input neuron of another PD block, according to some embodiments.

FIG. 5 illustrates a fully analog implementation of a chip component, comprising two fully dynamical (FD) block components and a relay oscillator, wherein coupling between the relay oscillator and an output oscillator of a FD block may be turned on or off, according to some embodiments.

FIG. 6A illustrates a package of a hierarchical thermodynamic computing architecture, wherein the package has multiple chips, wherein a given chip has multiple blocks, according to some embodiments.

FIG. 6B illustrates a package of a hierarchical thermodynamic computing architecture, wherein an underlying graph has a structure other than a tree structure, according to some embodiments.

FIG. 7A illustrates relay oscillators representing visible and latent variables in a hierarchical thermodynamic computing architecture, according to some embodiments.

FIG. 7B illustrates a subsection of the hierarchical thermodynamic computing architecture of FIG. 7A, wherein nested Gibbs sampling is performed for a single chip of the hierarchical thermodynamic computing architecture, according to some embodiments.

FIG. 8A illustrates measurement results for relay oscillators of a hierarchical thermodynamic computing architecture being provided to an FPGA/ASIC chip, wherein the measurement results may be used to perform parameter update rules, according to some embodiments.

FIG. 8B illustrates a pipeline for parameter updates for a hierarchical thermodynamic computing architecture, wherein some parameter update computations may be performed on classical computing devices and other parameter update computations may be performed using thermodynamic processors, according to some embodiments.

FIG. 9A illustrates a forwards pass of Gibbs sampling using partially dynamical (PD) blocks, wherein a relay oscillator is clamped to measured output thermodynamic data of a PD block, according to some embodiments.

FIG. 9B illustrates a backwards pass of Gibbs sampling using partially dynamical (PD) blocks, wherein thermodynamic data of input oscillators are measured, according to some embodiments.

FIG. 10A illustrates a forwards pass of Gibbs sampling using fully dynamical (FD) blocks, wherein a relay oscillator is clamped to output oscillators of a FD block, according to some embodiments.

FIG. 10B illustrates a backwards pass of Gibbs sampling using fully dynamical (FD) blocks, wherein a relay oscillator is clamped to input oscillators of a FD block, according to some embodiments.

FIG. 11 illustrates a flowchart that describes performing Gibbs sampling using hierarchical architecture, according to some embodiments.

FIG. 12A illustrates additional details of a relay gadget implemented using a thermodynamic processor, wherein the relay gadget is configured to relay thermodynamic information between a first energy-based model (EBM) and a second energy-based model (EBM), such as a block of a hierarchical thermodynamic computing architecture, according to some embodiments.

FIG. 12B is a high-level diagram similar to FIG. 12A, wherein the relay gadget does not include a bias oscillator, according to some embodiments.

FIG. 13 is a high-level flowchart illustrating a process of relaying thermodynamic information between an output oscillator, such as of a first energy-based model (EBM), and an input oscillator, such as a block of a hierarchical thermodynamic computing architecture, according to some embodiments.

FIG. 14 is a high-level diagram illustrating an output oscillator, an input oscillator, and a relay gadget, wherein the relay gadget comprises a group of relay oscillators and is configured to relay expectation values of thermodynamic information between the output oscillator and the input oscillator, according to some embodiments.

FIG. 15 is a high-level diagram illustrating a spatial analogue relay gadget, wherein respective ones of relay oscillators of a group of relay oscillators are configured to store respective sample values of an output oscillator, according to some embodiments.

FIG. 16 is a high-level diagram illustrating a temporal analogue relay gadget comprising two relay oscillators, according to some embodiments.

FIG. 17 is a high-level diagram illustrating a series analogue relay gadget, wherein a group of relay oscillators comprises a plurality of relay oscillators arranged in series, according to some embodiments.

FIG. 18A illustrates example couplings between visible neurons of an energy-based model (EBM), according to some embodiments.

FIG. 18B illustrates example couplings between visible neurons and non-visible neurons (e.g., hidden neurons) of an energy-based model (EBM), according to some embodiments.

FIG. 19 is a high-level diagram illustrating a process of determining weights and biases to be used in an energy-based model (EBM), wherein the weights and biases are determined using measurement values for synapse oscillators, according to some embodiments.

FIG. 20 is a high-level diagram illustrating a process of determining weights and biases to be used in an energy-based model (EBM), wherein the weights and biases are computed using a classical computing device, according to some embodiments.

FIG. 21A is high-level diagram illustrating an example neuro-thermodynamic computer comprising a thermodynamic processor (e.g., that implements a hierarchical thermodynamic computing architecture, and a relay gadget) included in a dilution refrigerator and coupled to a classical computing device in an environment external to the dilution refrigerator, according to some embodiments.

FIG. 21B is high-level diagram illustrating an example neuro-thermodynamic computer comprising a thermodynamic processor (e.g., that implements a hierarchical thermodynamic computing architecture, and a relay gadget) included in a dilution refrigerator and coupled to a classical computing device that is also included in the dilution refrigerator, according to some embodiments.

FIG. 22 is high-level diagram illustrating an example neuro-thermodynamic computer comprising one or more thermodynamic processors (e.g., that implement a hierarchical thermodynamic computing architecture, and a relay gadget) coupled to a classical computing device in an environment other than a dilution refrigerator, according to some embodiments.

FIG. 23 is a high-level diagram illustrating oscillators included in a substrate of a thermodynamic processor and a mapping of the oscillators to logical neurons or synapses of the thermodynamic processor, according to some embodiments.

FIG. 24 is an additional high-level diagram illustrating oscillators included in a substrate of a thermodynamic processor mapped to logical neurons, weights, and biases (e.g., synapses) of a neuro-thermodynamic computing system, according to some embodiments.

FIG. 25 is a block diagram illustrating an example computer system that may be used in at least some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof.

### DETAILED DESCRIPTION

The present disclosure relates to methods, systems and an apparatus for performing computer operations using a thermodynamic processor and more specifically performing Gibbs sampling on a hierarchical thermodynamic computing architecture. A hierarchical thermodynamic computing architecture may include blocks of energy based models (EBMs), collections of blocks to form a chip, collections of chips to form a package, and a collection of packages to form an ensemble. Relay oscillators or relay gadgets may be used to couple respective blocks to each other, couple respective chips to each other, and couple respective packages to each other. Relay oscillators or relay gadgets may be sampled to obtain thermodynamic information regarding a respective block, chip, package, or ensemble. For example, such sampling may be Gibbs sampling of a probability distribution implemented using the hierarchical thermodynamic computing architecture. To obtain samples, thermodynamic data of the relay oscillators or relay gadgets may be measured. In some embodiments, measurements are not necessary, and all computations may be performed using thermodynamic data. In some embodiments, a combination of measurements and thermodynamic processing may be used. Generally, multiple types of computations, (e.g., Gibbs sampling) can be greatly accelerated when implemented on a thermodynamic processor. Implementation of Gibbs sampling on thermodynamic processors may enable significantly faster sampling times by taking advantage of the fast equilibrium times of superconducting elements.

In some embodiments, oscillators of one or more thermodynamic processors may be configured to be coupled to each other, wherein the oscillators and the couplings implement one or more engineered energy potential for an energy based models (EBMs), wherein the one or more EBMs corresponds to a probability distribution function. Furthermore, the oscillators may obtain thermodynamic data corresponding to parameters of the EBMs. Thermodynamic data may include position, frequency, and force describing a given oscillator. Parameters of the EBM may be configured to be adjusted so that an EBM may be trained using training data. Such adjustable parameters may refer to weights and biases (e.g., synapse values), associated with respective neuron oscillators, for the EBM. One or more relay oscillators of the one or more thermodynamic processors may comprise adjustable masses or frequencies, wherein the oscillators and the one or more relay oscillators implements a block layer of a hierarchical thermodynamic computing architecture. Furthermore, one or more classical controllers may be used to send pulses to cause couplings between the oscillators and the one or more relay oscillators to be turned on or off. The pulses may also cause oscillators to be initialized to thermodynamic data from a prior thermodynamic evolution. Furthermore, the pulses may enable a product of mass and frequency squared of the one or more relay oscillators to be increased by adjusting the adjustable masses or frequencies. Such increasing the product of mass and frequency squared may cause the relay oscillators to be clamped to thermodynamic data of the relay oscillator, wherein said clamping maintains the thermodynamic data of the relay oscillator to be about the same before and after a given thermodynamic evolution. Some pulses may cause the oscillators to perform one or more thermodynamic evolutions, wherein the thermodynamic data from a prior thermodynamic evolution evolves to become evolved thermodynamic data. Other pulses may cause respective ones of the evolved thermodynamic data, encoded in a position or a momentum degree of freedom of respective ones of the oscillators, to be obtained wherein the obtained thermodynamic data are Gibbs sampling values for respective ones of the parameters implemented by the oscillators.

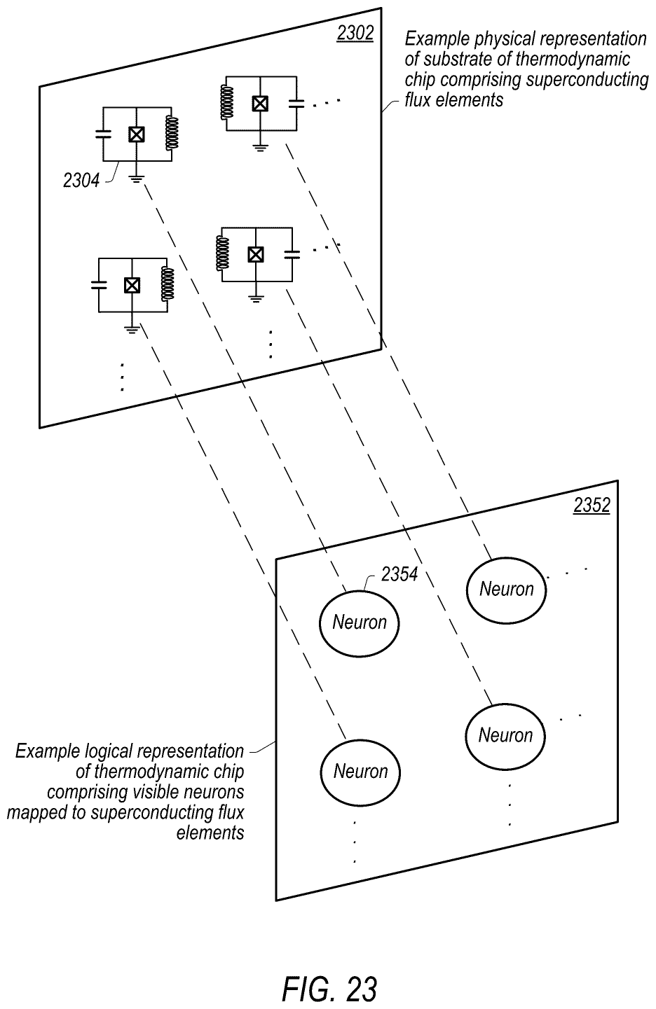

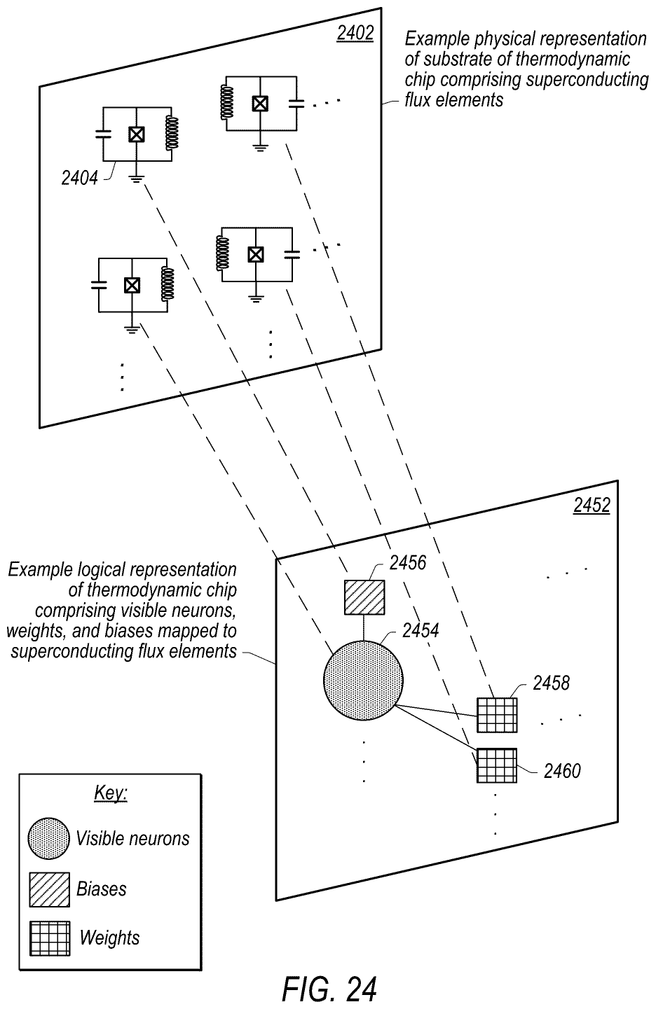

For example, a hierarchical thermodynamic computing architecture may include the following components. In some embodiments, a thermodynamic processor may comprise elements that may evolve like an oscillator. Such elements may be referred to as oscillators of the thermodynamic processor. An oscillator may be made of superconducting elements, wherein degrees of freedom such as position, momentum, and force may be encoded in thermodynamic data of the superconducting elements. See FIGS. 23-24 for more discussion on implementing an oscillator in hardware. Furthermore, the thermodynamic data may evolve according to engineered energy potentials, implemented by coupling oscillators with each other, to perform calculations thermodynamically. Oscillators may be coupled together in one or more arrangements to implement a desired function. Such a collection of oscillators implementing the function may be referred to as an energy based model (EBM). For example, input oscillators of a given EBM may receive input thermodynamic data, additional oscillators may be used to aid in processing received input thermodynamic data, and output oscillators may provide output thermodynamic data. For example, an EBM may be used to compute a conditional probability distribution such as the probability of measuring output thermodynamic data given input thermodynamic data. Multiple measurements may be performed (e.g., Gibbs samples may be obtained) to find an expectation value for the EBM.

In some embodiments, a hierarchical thermodynamic computing architecture may include a hierarchy of EBMs that may be accessible for sampling. For example, EBMs may be accessible for sampling at a block level, a chip level, a package level, and an ensemble level. EBMs may be accessible for sampling via access to relay oscillators used to link blocks, chips, packages, or ensembles together. Sampling may include measuring thermodynamic data of a given relay oscillator (or relay gadget) or transferring the thermodynamic data of the given relay oscillator to other oscillators (e.g., other relay oscillators). Note that blocks, chips, packages, and ensembles may be coupled with each other using the relay oscillators (or relay gadgets). Furthermore, the hierarchy of EBMs (e.g., blocks, chips, packages, ensembles) enables nested sampling, wherein a subset of blocks (or chips or packages) may be sampled from. Thus, the hierarchical thermodynamic computing architecture allows for sections or subsections of EBMs to be sampled from without having to utilize the entire thermodynamic computing architecture.

Relay oscillators and relay gadgets communicate thermodynamic information (e.g., data) in an analog manner. This can be contrasted with other approaches to communicate information that involve reading out thermodynamic information, such as using a classical computing device, and then relaying the information in classical form. For example, the ability to relay thermodynamic information directly between components in a neuro-thermodynamic computer (e.g., blocks, chips, packages, ensembles) avoids issues associated with readout to a classical computing device, such as read-out error, loss of information, and/or delays associated with performing readout. Moreover, if the information is to be used by another component of a neuro-thermodynamic computing device, relay of the information in a thermodynamic state avoids other delays such as would be incurred if required to initialize a receiving component to have an initial state corresponding to a state of the thermodynamic information that was read out from another component, wherein the relayed information is not already in a thermodynamic state. In some embodiments, such relay techniques as described herein may be used to relay thermodynamic information between energy-based models (EBMs). Such energy-based models (EBMs) may include trained models that evolve according to Langevin dynamics, and which may be used to generate inferences, such as machine learning (ML) inferences. For example, an ML model used to generate an ML inference may be physically implemented as a trained energy-based model (EBM). For example, a block of a hierarchical thermodynamic computing architecture described herein may be one such EBM, configured with an engineered potential that implements a probability distribution function.

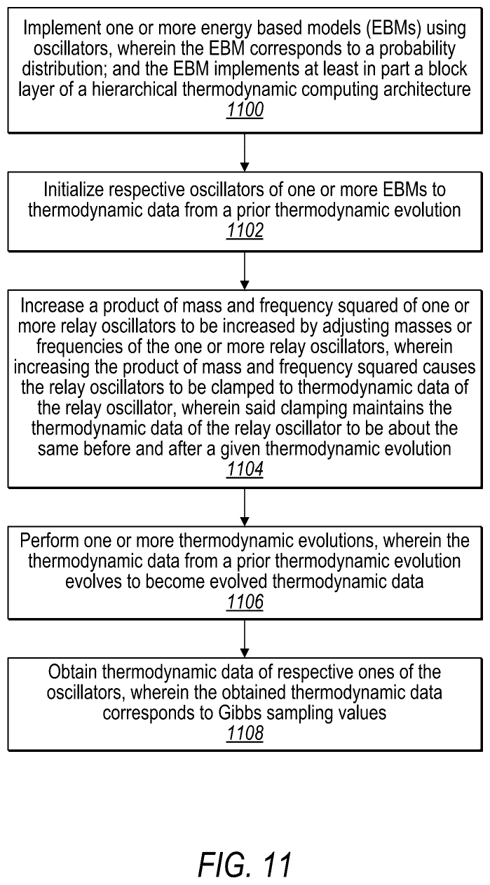

As described in FIGS. 11A-16, a relay oscillator or relay gadget provides a solution to controlling thermal information flow without having to rely on varying mass and frequency combinations between components to drive the thermodynamic information flow. For example, a relay gadget includes a relay oscillator that has a controllably adjustable mass and/or frequency that can be used to couple to oscillators belonging to other modules. This allows controlled thermodynamic information flow without having to worry about relative mass and/or frequency sizing between oscillators of the components (e.g., such as oscillators of an EBM block and oscillators of another EBM block). For example, using a relay oscillator reduces the required constraints on the selection of parameters for oscillators belonging to different modules. The relay oscillator can also be used to obtain samples from various degrees of freedom of an oscillator. Such samples can be used to do Gibbs sampling.

At a physical level, the thermodynamic processor harnesses electron fluctuations in superconductors coupled in flux loops to model Langevin dynamics. In some embodiments, architectures such as those described herein may resemble a partial self-learning architecture, wherein classical computing device(s) (e.g., a FPGA, ASIC, etc.) may be relied upon only to perform simple tasks such as summing measured values and performing other non-compute intensive operations in order to implement a learning algorithm.

Note that in some embodiments, electro-magnetic or mechanical (or other suitable) oscillators may be used. A thermodynamic processor may implement neuro-thermodynamic computing and therefore may be said to be neuromorphic. For example, the neurons implemented using the oscillators of the thermodynamic processor may function as neurons of a neural network that has been implemented directly in hardware. Also, the thermodynamic processor is “thermodynamic” because the chip may be operated in the thermodynamic regime, wherein thermodynamic effects cannot be ignored. For example, some thermodynamic processors may be operated within the milli-Kelvin range, and/or at 2, 3, 4, etc. degrees Kelvin. The term thermodynamic processor also indicates that the thermal equilibrium dynamics of the neurons are used to perform computations. In some embodiments, temperatures less than 15 Kelvin may be used. Though other temperatures ranges are also contemplated. For example, some suitable types of oscillators may operate around room temperature. Neuro-thermodynamic computing, in some contexts, may be referred to as analog stochastic computing. In some embodiments, the temperature regime and/or oscillation frequencies used to implement the thermodynamic processor may be engineered to achieve certain statistical results. For example, the temperature, friction (e.g., damping) and/or oscillation frequency as well as masses, may be controlled variables that ensure the oscillators evolve according to a given dynamical model, such as Langevin dynamics. In some embodiments, temperature may be adjusted to control a level of noise introduced into the evolution of the neurons. As yet another example, a thermodynamic processor may be used to model energy models that require a Boltzmann distribution. Also, a thermodynamic processor may be used to solve variational algorithms and perform learning tasks and operations.

In some embodiments, Gibbs sampling can be used to sample from conditional distributions. Furthermore, Gibbs sampling can be implemented in the context of energy based models (EBMs). In particular, deterministic models can be converted to probabilistic graphical models and then use Gibbs sampling to sample conditional distributions from such models.

For example, a graph may have input neurons labelled x, and l hidden layers. The j'th layer contains the hidden variables which may be labeled zⱼ. Now if the graph is a directed graph, with the parent nodes of zⱼ being zⱼ₋₁, the total probability distribution may be written as

$$p ( x , {z}_{1} , … , {z}_{l} ) = p ( x ) p ( {z}_{1} \vert x ) {\prod }_{k = 2}^{l} p ( {z}_{k} \vert {z}_{k - 1} ) . \qquad ( eq . 1 )$$

Using Bayes rule, the conditional probability distribution of x given hidden variables z is

$$p ( z \vert x ) = p ( {z}_{1} \vert x ) {\prod }_{k = 2}^{l} p ( {z}_{k} \vert {z}_{k - 1} ) . \qquad ( eq . 2 )$$

In this setting, the Gibbs sampling algorithm may works as follows.
Step 1: Initialize z₁, . . . , zₗ to some values (or from some prior distribution).
Step 2: Sample z₁˜p(z₁|x).
Step 3: For all k∈{2, . . . , l}, sample zₖ˜p(zₖ|zₖ₋₁) (in increasing order of k).
Step 4: Repeat steps 2 and 3 until convergence.

In the case where the graph is not directed, the joint probability distribution cannot be factorized as in eq. 1. In this setting, the more general Gibbs sampling algorithm may work as follows.
Step 1: Initialize z₁, . . . , zₗ to some values (or from some prior distribution).
Step 2: For all k∈{1, . . . l}, sample zₖ˜p(zₖ|x, z₁, . . . , zₖ₋₁, zₖ₊₁, . . . , zₗ) (in increasing order of k).
Step 3: Repeat step 2 until convergence.

In some embodiments, output of a deterministic function may be sampled using EBMs. For example, a deterministic function ƒ which takes an input xₗ₋₁ and outputs xₗ, may be written as

$${x}_{l} = f ( {x}_{l - 1} ) , \qquad ( eq . 3 )$$

where ƒ is applied element-wise to the vector xₗ₋₁. If the input neurons are clamped to xₗ₋₁, an approximate solution to xₗ=ƒ(xₗ₋₁) is obtained by sampling from

$$p ( {x}_{l} \vert {x}_{l - 1} ) = \frac{{e}^{- ℰ ( {x}_{l - 1} , {x}_{l} )}}{Z ( {x}_{l - 1} )} , \qquad ( eq . 4 )$$

with

$$Z ( {x}_{l - 1} ) = \int {e}^{- ℰ ( {x}_{l - 1} , {x}_{l} )} d {x}_{l} . \qquad ( eq . 5 )$$

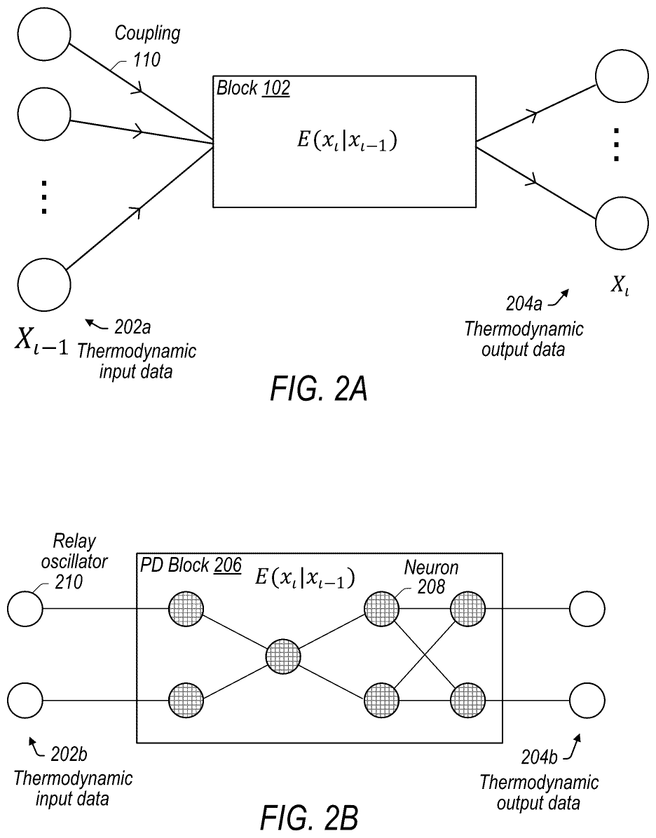

The energy function may be given by

$$ℰ ( {x}_{l - 1} , {x}_{l} ) = D ( {x}_{l} , f ( {x}_{l - 1} ) ) , \qquad ( eq . 6 )$$

where D is some distance function between xₗ and ƒ(xₗ₋₁) which is minimized when xₗ=ƒ(xₗ₋₁). The goal then is to define a potential energy function in hardware that maps to D. An illustration of this setting is shown in FIG. 2A. Some embodiments may have effective hidden layers in a given EBM block. For example, suppose a feedforward neural network has one hidden layer that computes the function xₗ=ƒ(Axₗ₋₁+b) for some matrix A and bias vector b. It may be set that z=Axₗ₋₁+b and it may be defined that D_{L}=(z-Axₗ₋₁-b)^{T}(z-Axₗ₋₁-b) as the distance function for the linear constraint, and a potential U_{L} (linear potential) may be chosen to map to D_{L}-b^{T}b. Then, a potential U_{NL} (non-linear potential) may be defined that maps to a distance D_{NL}(x₁, z) and take ε(xₗ₋₁, xₗ)=U_{L}(xₗ₋₁, z)+U_{NL}(xₗ, Z).

Note that if the input to the function ƒ is un-clamped (e.g., not fixed to a given value), the samples for the output neurons would no longer be obtained from the distribution in eq. 4. Instead, they would be obtained from the distribution

$$p ( {x}_{l - 1} , {x}_{l} ) = \frac{{e}^{- ℰ ( {x}_{l - 1} , {x}_{l} )}}{Z} , \qquad ( eq . 7 )$$

where Z is given by

$$Z = \int {e}^{- ℰ ( {x}_{l - 1} , {x}_{l} )} d {x}_{l - 1} d {x}_{l} . \qquad ( eq . 8 )$$

In some embodiments, a Gaussian distribution may be used to represent the conditional probabilities (as long as the non-linearities of the function ƒ can be accommodated in hardware) when using the appropriate distance function D which may be

$$D = {λ ( {x}_{l} - f ( {x}_{l - 1} ) )}^{2} , \qquad ( eq . 9 )$$

where now the probability distribution in eq. 4 is a Gaussian with mean ƒ(xₗ₋₁) and a diagonal covariance matrix with the diagonal elements given by λ. More generally, a distance function may be written as

$$\begin{matrix}D = \frac{1}{2} {( {x}_{l} - f ( {x}_{l - 1} ) )}^{T} {\sum }^{- 1} ( {x}_{l} - f ( {x}_{l - 1} ) ) \\ = \frac{1}{2} {\sum }_{i , j} ( {x}_{l}^{( i )} - {f ( {x}_{l - 1} )}^{( i )} ) {( {\sum }^{- 1} )}_{ij} ( {x}_{l}^{( j )} - {f ( {x}_{l - 1} )}^{( j )} ) ,\end{matrix} \qquad ( eq . 10 )$$

where the second line in eq. 10 is written as a sum of energy functions which can be engineered with appropriate couplings between the input and output nodes when considering a general covariance matrix Σ.

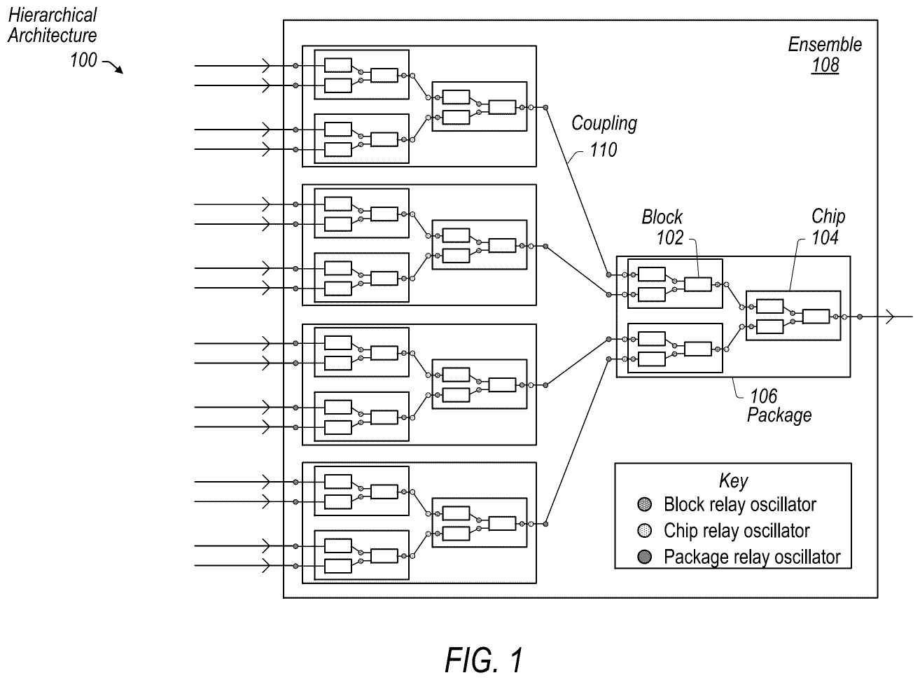

Now, suppose the state of the neurons xₗ in a network with the appropriate choice of potential energy ε(xₗ, xₗ₋₁) for some clamped inputs xₗ₋₁ may be measured. Such measurements could then be used to obtain the required samples from p(xₗ|xₗ₋₁) for the Gibbs sampling algorithm described above. FIG. 1, for example, describes a hierarchical architecture for EBMs for performing Gibbs sampling. The hierarchical architecture may consist of relay oscillators which will allow measurements of an output layer to be obtained. The relay oscillators will effectively copy and freeze the state of a neuron in an output layer (with neurons being encoded into oscillators on a superconducting device). Thus, measuring the state of the relay oscillator will provide the desired samples. The relay oscillators can then by coupled to the next EBM block part of the hierarchy.

FIG. 1 illustrates a hierarchical thermodynamic computing architecture made using energy based model (EBM) blocks, wherein Gibbs sampling may be performed using relay oscillators representing inputs and latent variables, according to some embodiments.

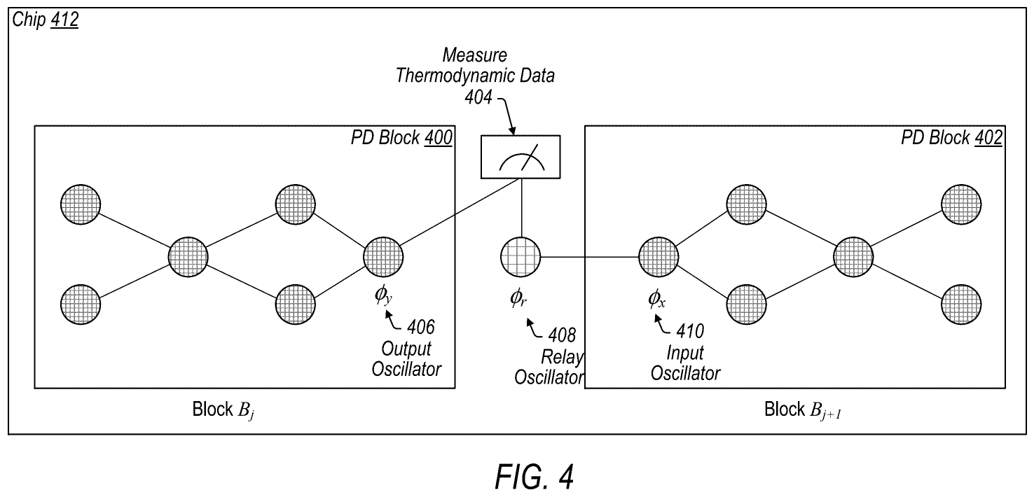

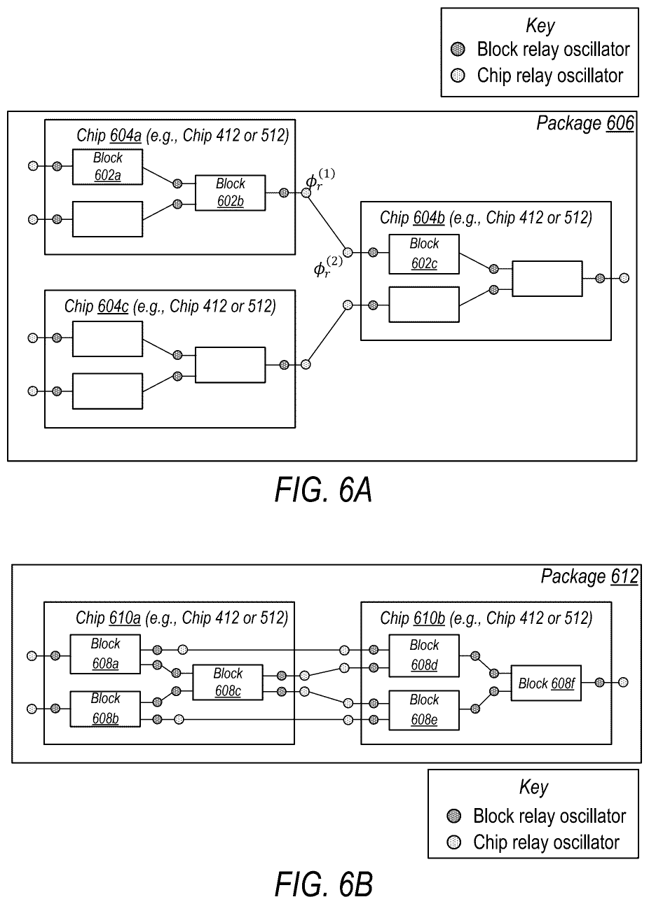

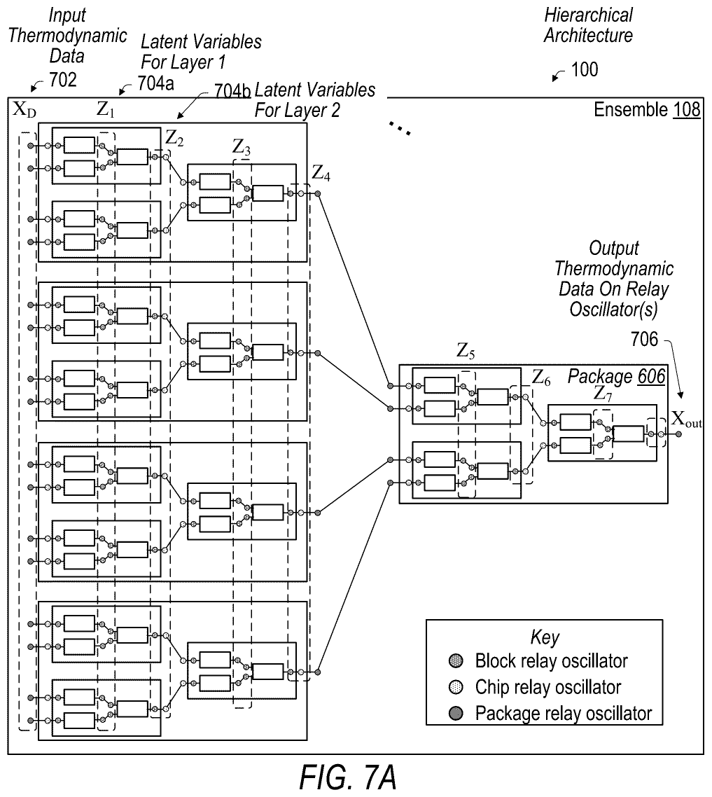

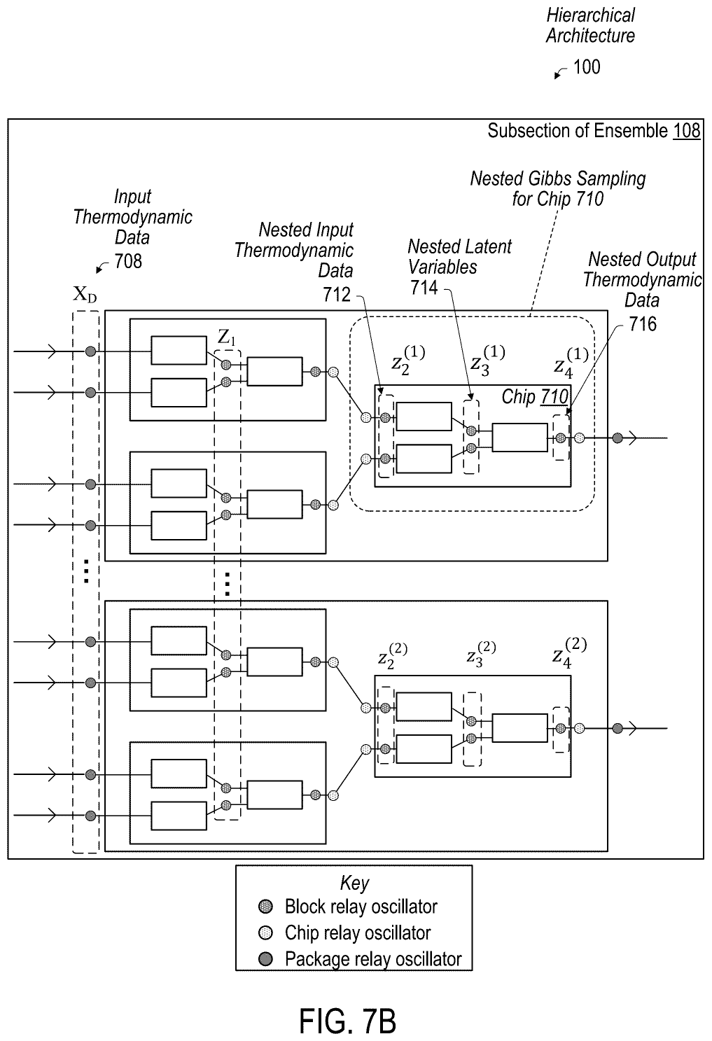

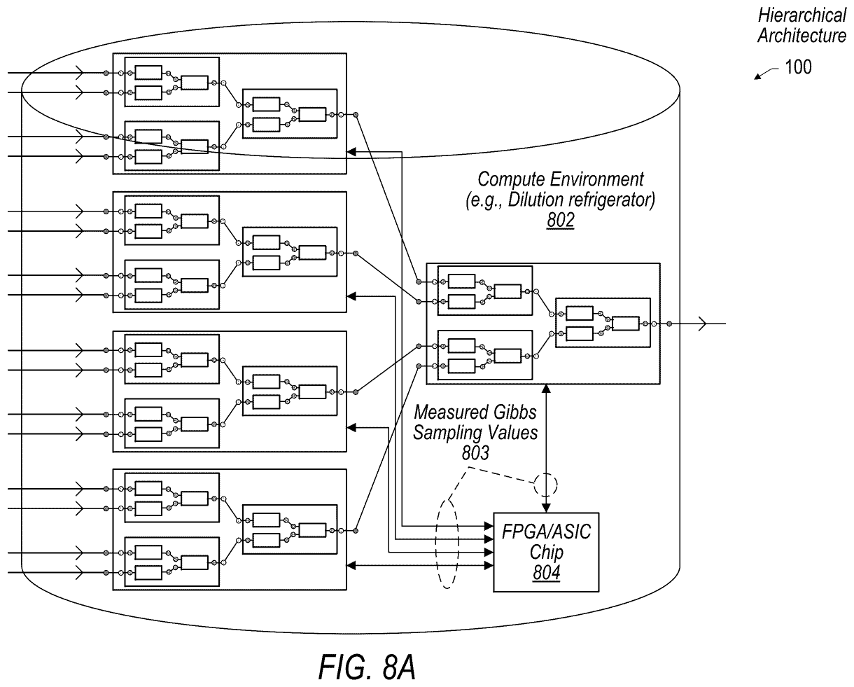

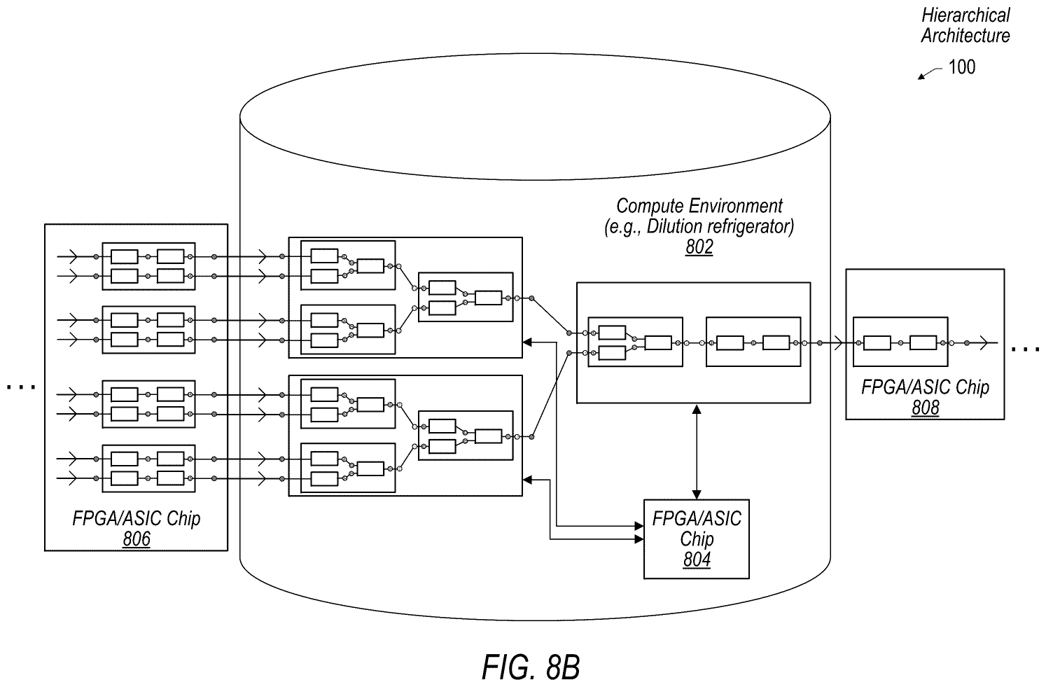

In some embodiments, a hierarchical thermodynamic computing architecture (also referred to as hierarchical architecture 100) may consists of a blocks 102 which can be mapped to an energy function (see FIGS. 2A-5 for a discussion on blocks). Blocks 102 can be coupled to each other and form chip 104 component (see FIGS. 4-6B for a discussion on chips). Chips 104 may also be coupled with each other with the use of additional relay oscillators, and such components are referred to as a package 106 (see FIGS. 6A-7B for a discussion on packages). Finally, there may be couplings between packages, and such an ensemble 108 resides within a computing environment such as a dilution refrigerator (see FIGS. 8A-8B for a discussion on ensembles). In some embodiments, multiple ensembles may be coupled together, wherein each ensemble is in a separate dilution refrigerator. Having a hierarchy of EBM blocks enables the implementation of nested Gibbs sampling and may be used for hardware architecture where connectivity is limited.

In some embodiments, a hierarchical architecture 100 may be used to perform Gibbs sampling. Consider an ensemble 108 which contains multiple EBM blocks such as block 102, where each EBM block has its own energy potential and performs some computation. A given EBM block may have input and output neurons which are coupled to other EBM blocks via relay oscillators. However, there may be a hierarchy of communication between blocks which have different latency's and speed. Furthermore, nested Gibbs sampling may be performed on subgraphs of the entire graph represented by all the EBM blocks in ensemble 108. FIGS. 2A-6, describe the various components of the hierarchy in more detail. FIGS. 7A-10B describe a hierarchical Gibbs sampling algorithm using hierarchical architecture 100.

FIG. 2A illustrates an energy based model (EBM) used to compute a conditional probability distribution with inputs and outputs as thermodynamic data, according to some embodiments.

In some embodiments, an EBM may be used to compute a conditional probability distribution p(xₗ|xₗ₋₁) in eq. 4 using block 102. To obtain a Gaussian distribution, an energy function may be engineered using oscillators as in eq. 9. In general, an EBM may be treated as a block which implements the desired conditional probability distribution. Block 102 may couple with oscillators (illustrated by coupling 110) to obtain thermodynamic input data 202a. Oscillators of block 102 may thermodynamically evolve wherein coupling between block 102 and output oscillators may enable the output oscillators to obtain thermodynamic output data 204a provided by block 102.

FIG. 2B illustrates an example energy based model (EBM) of a block of a hierarchical thermodynamic computing architecture that is partially dynamical (PD), wherein oscillators of the EBM implement neurons while synapses of the EBM are encoded in hardware, according to some embodiments.

In some embodiments, PD block 206 may have neurons such as neuron 208 implemented by oscillators which are coupled to each other. The coupling of the oscillators representing neurons is engineered to form an engineered energy potential for an EBM. The weights and biases for the neurons may be updated on an FPGA/ASIC chip. The input and output neurons in the block may be coupled to relay oscillators such as relay oscillator 210.

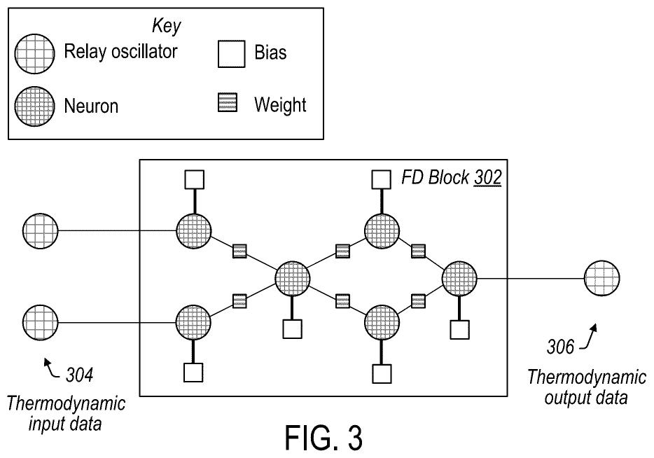

In some embodiments, block components such as block 102 or PD block 206 are used as a core level of hierarchical architecture 100. FIG. 2B illustrates a block component where the synapses (weights and biases) are updated in software on an FPGA/ASIC chip (e.g., PD block 206). Note that FIG. 3 illustrates the case where the synapses are implemented using oscillators that may undergo Langevin dynamics. For PD block 206, “PD” is an acronym for partially dynamical, since the synapses are not represented by physical harmonic oscillators.

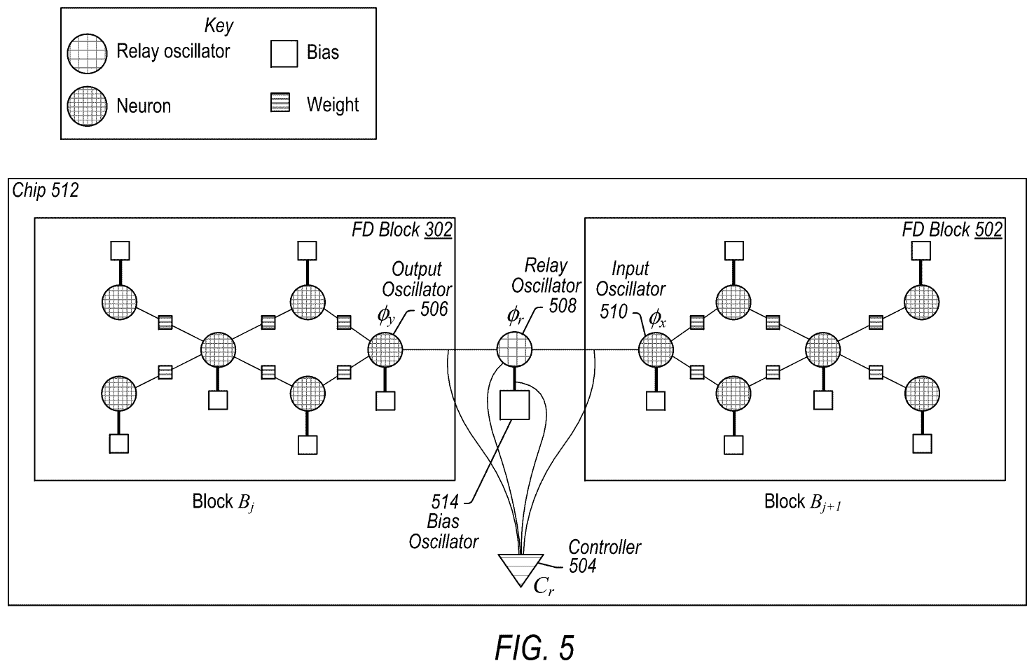

In some embodiments, components of PD block 206 consists of coupled neurons (e.g., neuron 208) which undergo Langevin dynamics (e.g., thermodynamic evolution according to an engineered energy potential of the EBM), with weights and biases updated in software using measured samples as described in FIGS. 7A-10B. Neurons in the first and last layer of a block are coupled to relay oscillators (e.g., relay oscillator 210). More details on the use of relay oscillators are provided in FIGS. 4-5. A Hamiltonian (e.g., engineered energy potential) describing the dynamics (e.g., thermodynamic evolution) of the neurons may be written as

$${H}_{{B}_{j}} = {\sum }_{j ∈ {V}_{{B}_{j}}} ( \frac{{π}_{{n}_{j}}^{2}}{2 {m}_{{n}_{j}}^{( v )}} + {{E}_{L}^{( v )} ( {ϕ}_{{n}_{j}} - {\tilde{ϕ}}_{L}^{( v )} )}^{2} + {E}_{J 0}^{( v )} cos ( {\tilde{ϕ}}_{DC}^{( v )} / 2 ) ( 1 - cos ( {ϕ}_{{n}_{j}} ) ) ) + ( α {\sum }_{k , l ∈ {ℰ}_{{B}_{j}}} {φ}_{{s}_{k l}} {ϕ}_{{n}_{k}} {ϕ}_{{n}_{l}} + β {\sum }_{j ∈ {V}_{{B}_{j}}} {ϕ}_{{n}_{j}} {φ}_{{b}_{j}} ) , \qquad ( eq . 11 )$$

where ϕ is used to denote the position degree of freedom of an oscillator, and π its momentum degree of freedom. The first line in eq. 11 describes the potential and kinetic terms of the neurons, and the second term represents the couplings between the neurons. Since the synapses are not physical oscillators, φₛ_{ₖₗ} is used to denote the value of the weights, and φ_{b}_{ⱼ} for the biases instead of φₛ_{ₖₗ} and ϕ_{b}_{ⱼ}. A set of neurons in block j is denoted as ν_{B}_{ⱼ}. The set of weights is denoted as ε_{b}_{ⱼ}. Note that in eq. 11, couplings between the neurons and relay oscillators are omitted (e.g. relay oscillator 210). However, such couplings are present, as described by the analogue relay oscillator gadget herein.

In some embodiments, the neurons used to encode the data are based on a flux qubit design. Neurons are described by a phase/flux degree of freedom and the design is based on a DC SQUID (superconducting quantum interference device) which contains two junctions. In eq. 11, Eⱼ denotes the Josephson energy, L corresponds to the inductance of the main loop, and results in the inductive energy E_{L}. \tilde{ϕ}_{L} is the external flux coupled to the main loop and \tilde{ϕ}_{DC} is the external flux coupled into the DC SQUID loop.

The Langevin equation of motion (e.g., representing the thermodynamic evolution of the oscillators) for oscillators in a given PD block is

$$\frac{d {ϕ}_{k} ( t )}{d t} = \frac{\partial {H}_{tot}}{\partial {π}_{k}} \qquad ( eq . 12 )$$

$$\frac{d {π}_{k} ( t )}{d t} = - {γπ}_{k} ( t ) - \frac{\partial {H}_{tot}}{\partial {ϕ}_{k}} {\vert}_{t} + \sqrt{2 {m}_{k} γ {k}_{B} T} \frac{d {W}_{t}}{d t} , ∖ \qquad ( eq . 13 )$$

where Wₜ corresponds to a Wienner process.

FIG. 3 illustrates an example energy based model (EBM) of a block of a hierarchical thermodynamic computing architecture that is fully dynamical (FD), wherein oscillators implement neurons and synapses of the EBM block, according to some embodiments.

In some embodiments, a block such as FD block 302 may have oscillators that represent the neurons, as well as oscillators that represent the synapses (weights and biases). Each neuron is coupled to a bias oscillator, which are illustrated using squares. The oscillators acting as weights to couple different neurons are illustrated as hashed squares.

In some embodiments, a fully dynamical (FD) implementation of a block component (e.g., FD block 302) may be used in a hierarchical architecture 100. In this setting, a FD block component contains oscillators for the neurons, as well as oscillators to represent the synapses (i.e. weights and biases). The Hamiltonian that represents the dynamics of the FD block component may be given by

$${H}_{{B}_{j}} = {\sum }_{j ∈ {V}_{{B}_{j}}} ( \frac{{π}_{{n}_{j}}^{2}}{2 {m}_{{n}_{j}}^{( v )}} + {{E}_{L}^{( v )} ( {ϕ}_{{n}_{j}} - {\tilde{ϕ}}_{L}^{( v )} )}^{2} + {E}_{J 0}^{( v )} cos ( {\tilde{ϕ}}_{DC}^{( v )} / 2 ) ( 1 - cos ( {ϕ}_{{n}_{j}} ) ) ) + {\sum }_{j ∈ {V}_{{B}_{j}}} ( \frac{{π}_{{b}_{j}}^{2}}{2 {m}_{{b}_{j}}^{( b )}} + {{E}_{L}^{( b )} ( {ϕ}_{{b}_{j}} - {\tilde{ϕ}}_{L}^{( b )} )}^{2} + {E}_{J 0}^{( b )} cos ( {\tilde{ϕ}}_{DC}^{( b )} / 2 ) ( 1 - cos ( {ϕ}_{{b}_{j}} ) ) ) + {\sum }_{j ∈ {ℰ}_{{B}_{j}}} ( \frac{{π}_{{w}_{j}}^{2}}{2 {m}_{{w}_{j}}^{( w )}} + \text{} {{E}_{L}^{( w )} ( {ϕ}_{{w}_{j}} - {\tilde{ϕ}}_{L}^{( w )} )}^{2} + \text{} {E}_{J 0}^{( w )} cos ( {\tilde{ϕ}}_{DC}^{( w )} / 2 ) ( 1 - cos ( {ϕ}_{{w}_{j}} ) ) ) + ( α {\sum }_{\{ k , l \} ∈ {ℰ}_{{B}_{j}}} {ϕ}_{{s}_{k l}} {ϕ}_{{n}_{k}} {ϕ}_{{n}_{l}} + β {\sum }_{j ∈ {V}_{{B}_{j}}} {ϕ}_{{n}_{j}} {ϕ}_{{b}_{j}} ) , \qquad ( eq . 14 )$$

The first line in eq. 14 represents the kinetic and potential terms for the neurons. The second line represents the kinetic and potential terms for the bias neurons (squares in FIG. 3). The third line represents the kinetic and potential term for the weights (hashed squares in FIG. 3). Finally, the fourth line represents coupling between the neurons and synapses. Notice that instead of using φₛ_{ₖₗ} and φ_{b}_{ⱼ}, the terms ϕₛ_{ₖₗ} and ϕ_{b}_{ⱼ} are used since the synapses are encoded in the position degrees of freedom of physical harmonic oscillators. Having the synapses as dynamical degrees of freedom will allow gradients to be obtained by measuring the synapses, instead of having to compute the gradients directly on an FPGA/ASIC chip.

FIG. 4 illustrates an analogue-digit implementation of a chip component, comprising two partially dynamical (PD) block components and a relay oscillator, wherein a degree of freedom of an output neuron of a PD block is measured, a relay oscillator is clamped to the measured value, then the relay oscillator is coupled to an input neuron of another PD block, according to some embodiments.

In some embodiments, a next level of a hierarchical architecture (e.g., built upon a level of block components) include chip components (e.g., chip 412 or chip 506). The chip component contains multiple block components, with a subset of the blocks coupled through the use of block relay oscillators (see FIGS. 11A-16 for a description of the mechanics of relay oscillators). FIG. 5 give an example of two blocks coupled by a relay oscillator. The output neuron in the final layer of block Bⱼ (e.g., FD block 302) and the input neuron in the first layer of block Bⱼ₊₁ (e.g., FD block 502) are coupled to the relay oscillator. In some embodiments, the way the relay oscillator is used depends on whether it is coupled to PD or FD block components.

In some embodiments, chip 412 may implement an analogue digit implementation of the relay oscillator for PD block components (e.g., PD block 400 and 402). For example, a position degree of freedom of the output neuron (e.g., output oscillator 406 of PD block 400) is measured (e.g., measure thermodynamic data 404). A clamping potential of the form λ(ϕᵣ−y)² is then turned on for large values of A to clamp the relay oscillator (e.g., relay oscillator 408) at the measured value. Once the relay oscillator is clamped, it is then coupled to the input neuron (e.g., input oscillator 410) of the next PD block 402.

In some embodiments, chip 412 component may use an analogue-digital approach for the relay oscillator 408. For example, the position degree of freedom of the output neurons (e.g., output oscillator 406) of PD block 400 component may be measured. Suppose the measurement result is y for an output neuron with position degree of freedom ϕ_{y}. Given the measurement result, the relay oscillator 408 is clamped to the measured value y using a potential of the form

$${V}_{r} = \frac{1}{2} {m}_{r} {ω}_{r} {ϕ}_{r}^{2} + {λ ( {ϕ}_{r} - y )}^{2} , \qquad ( eq . 15 )$$

where mᵣ is the mass and ωᵣ the frequency of relay oscillator 408. The position degree of freedom of the relay oscillator 408 is written as ϕᵣ, and λ determines how strongly the relay oscillator 408 is clamped to the measured value y. Clamping relay oscillator 408 to the measured value y maintains the position degree of freedom of relay oscillator 408 approximately to the measured value y. After clamping the relay oscillator 408 to the measured value y, the relay oscillator is then coupled to an input oscillator of PD block 402. While a chip with two blocks is shown in FIG. 4, this does not limit the number of blocks a chip may include. A chip may include any number of blocks and any combination of networking between blocks using relay oscillators.

FIG. 5 illustrates a fully analog implementation of a chip component, comprising two fully dynamical (FD) block components and a relay oscillator, wherein coupling between the relay oscillator and an output oscillator of a FD block may be turned on or off, according to some embodiments.

In some embodiments, a chip may include a fully analogue implementation of a relay oscillator connecting two FD block components. For example, for chip 506, a coupling between the relay oscillator 508 and FD block 302 (e.g., block Bⱼ) can be turned on and off, as with its coupling with FD block 502 (e.g., block Bⱼ₊₁). A classical controller 504 (e.g., controller Cᵣ) determines the functional form of the coupling parameters as well as the functional form for either a time dependent mass or time dependent frequency of the relay oscillator 508. The position degree of freedoms of the output oscillator 506 belonging to FD block 302 (block Bⱼ) as are denoted as ϕ_{y}, and the input oscillator 510 belonging to FD block 502 (block Bⱼ₊₁) is denoted as ϕₓ. A bias oscillator 514, which is coupled to the relay oscillator 508, is also added and allows the relay oscillator to maintain its equilibrium value as the coupling with ϕ_{y} is turned off.

In some embodiments, a fully analogue implementation of chip 512 with relay oscillator 508 coupled to FD block 302 and FD block 502 may be used. Consider an FD EBM block with potential energy ε_{θ}(x, z). As will be described in FIGS. 7A-10B, when using an FD block, the goal may be to obtain a gradient of the potential energy (written as ∇_{θ}ε_{θ}(x, z)) for a fixed value of z (which is encoded in the position degree of freedom of the output neurons of the FD block). That is, the gradient may be sampled by measuring either the position or momentum degrees of freedoms of the synapses. To do so, the coupling between the output oscillator 506 (implementing a neuron) and the relay oscillator 508 is turned on very quickly, after which the product of the mass times frequency of the relay oscillator 508 is increased rapidly while still being coupled to the output oscillator 506, effectively clamping the position of both the relay oscillator 508 and the output oscillator 506. At that moment, either the position or momentum degrees of freedoms of the synapses (e.g., oscillators implementing weights and biases for FD block 302) are measured to obtain the gradient, and the coupling between the relay oscillator 508 and output oscillator 506 is turned off. The relay oscillator 508 is also coupled to a bias oscillator 514 to ensure that it maintains its equilibrium value after its coupling with the output oscillator 506 is turned off. The relay oscillator 508 coupling with the bias oscillator 514 is turned on rapidly once the product of mass times frequency of the relay oscillator 508 is increased. Once the coupling between the relay oscillator 508 and the output oscillator 506 of the FD block 302 is turned off, the coupling between the relay oscillator 508 and the input oscillator 510 of the next FD block 502 is turned on. A classical controller 502 (Cᵣ) is used to cause the functional form of the time-dependent couplings to be implemented.

The Hamiltonian of the relay oscillator 508, along with its coupling with the input oscillator 510 and output oscillator 506 belonging to two separate FD block components (FD block 302 and FD block 502) is given by

$${H}_{rel}^{( b )} = \frac{{π}_{r}^{2}}{2 {m}_{r}} + \frac{{π}_{y}^{2}}{2 {m}_{y}} + \frac{1}{2} {m}_{r} ( t ) {ω}_{r} ( t ) {ϕ}_{r}^{2} + {V}_{y} ( {ϕ}_{y} ) + {λ}_{A} ( t ) {( {ϕ}_{r} - {ϕ}_{y} )}^{2} + {λ}_{X} ( t ) {ϕ}_{r} {ϕ}_{x} + {λ}_{B} ( t ) {ϕ}_{b} {ϕ}_{r} , \qquad ( eq . 16 )$$

where ϕᵣ, ϕ_{y} ϕₓ are the position degrees of freedom of the relay 508, output 506 and input 510 oscillators. Note that a coupling of the form ϕᵣϕ_{y} can also be used instead of (ϕᵣ−ϕ_{y})². Similarly, a coupling of the form (ϕᵣ−ϕₓ)² can be used instead of ϕᵣϕₓ. The position degree of freedom of the bias oscillator 514 may be labeled as ϕ_{b}. The time dependence of either the mass mᵣ(t) or frequency φᵣ(t) of the relay oscillator 508 is made explicit in it's potential energy term given by

$$\frac{1}{2} {m}_{r} ( t ) {ω}_{r} ( t ) {ϕ}_{r}^{2} .$$

Note that tor brevity, in eq. 16 the coupling terms between ϕ_{y} and the other oscillators in its FD block 302, as well as the coupling between ϕₓ and the oscillators in its FD block 502 are not explicitly written but are present. Pulses may be used for λ_{A}(t), λₓ(t) and λ_{B}(t) that are based on sigmoid functions (although a variety of pulses may be used). For example, the pulses may be written as

$${λ}_{A} ( t ) = {λ}_{A} ( σ ( {k}_{A} ( t - {t}_{1}^{( A )} ) ) - σ ( {k}_{A} ( t - {t}_{2}^{( A )} ) ) ) {λ}_{X} ( t ) = {λ}_{X} σ ( {k}_{X} ( t - {t}_{1}^{( X )} ) ) + {λ}_{0}^{( X )} . {λ}_{B} ( t ) = {λ}_{B} σ ( {k}_{B} ( t - {t}_{1}^{( B )} ) ) + {λ}_{0}^{( B )} . \qquad ( eqs . 17 - 19 )$$

The parameters k_{A}, kₓ and k_{B} in eqs. 17-19 determine how quickly the couplings between the oscillators can be turned on or off. The times t₁^{(A)} and t₂^{(A)} determine when the coupling between between ϕᵣ and ϕ_{y} is turned on and off, as controlled by Cᵣ (and similarly for the other couplings, as determined by the time parameters in the sigmoid functions). Finally, the parameters λ_{A}, λₓ and λ_{B} determine the strength of the couplings. In some embodiments, since a snapshot of ϕ_{y} is to be obtained by imparting its value to the relay oscillator ϕᵣ, λ_{A} will need to be large.

In some embodiments, the frequency of the relay oscillator (instead of its mass) may be increased during its coupling with ϕ_{y} according to the following time dependent rule

$${ω}_{r} ( t ) = {ω}_{f}^{( r )} σ ( {k}_{r} ( t - {t}_{r} ) ) + {ω}_{r} . \qquad ( eq . 20 )$$

In some embodiments, the mass may be made time dependent instead of the frequency. Having a time dependent mass may require a Cooper pair box for the implementation of the relay oscillator.

Note that for FD block components, the relay oscillators as well as the output oscillators do not need to be measured as the relay oscillator protocol is fully analogue. However as mentioned above, the synapse oscillators in a given block are measured once the coupling between the relay oscillators and the output oscillators is turned on.

FIG. 6A illustrates a package of a hierarchical thermodynamic computing architecture, wherein the package has multiple chips, wherein a given chip has multiple blocks, according to some embodiments.

In some embodiments, multiple analogue relay oscillators are used to coupled FD block components belonging to different chips (e.g., chip relay oscillators). The coupling mechanism between two relay oscillators allows the equilibrium state of one relay oscillator to be transferred to another.

In some embodiments, there may be a coupling between block components Bⱼ and Bₖ in a given chip (e.g., between block 602a and block 602c). Hardware connectivity constrains may often prevent Bⱼ and Bₖ to be coupled using a single relay oscillator. For both PD and FD block components, there may be larger latency's and slower communication speeds between Bⱼ and Bₖ (either due to extra relay oscillators used for the communication (e.g., coupling between block 602b and block 602c), or longer communication times for PD block components). In the case of FD block components, additional analogue relay oscillators may be used to mediate the connectivity between the different block components. The same coupling protocol between two relay oscillators can be used as the one described above for a relay oscillator ϕᵣ coupled to ϕ_{y}. For example, the frozen state of the block 602b relay oscillator is copied to subsequent relay oscillators until the coupling between block 602b of chip 604a and block 602c of chip 604b is achieved. Thus, a package 606 component may contain multiple chip components, and a subset of FD or PD blocks in a given chip are coupled to FD or PD blocks in different chips using multiple relay oscillators.

For example, a Hamiltonian representing the coupling between two relay oscillators may be used. In some embodiments, a thermodynamic state of a relay oscillator ϕᵣ⁽¹⁾ which is coupled to a second relay oscillator ϕᵣ⁽²⁾, may be copied to ϕᵣ⁽²⁾. The Hamiltonian may be written as

$${H}_{cb}^{( b )} = \frac{{( {π}_{r}^{( 1 )} )}^{2}}{2 {m}_{r}^{( 1 )}} + \frac{{( {π}_{r}^{( 2 )} )}^{2}}{2 {m}_{r}^{( 2 )}} + {λ}_{1} ( t ) {ϕ}_{r}^{( 1 )} {ϕ}_{r}^{( 2 )} + {λ}_{{b}_{1}} {ϕ}_{r}^{( 1 )} {ϕ}_{b}^{( 1 )} + {λ}_{{b}_{2}} {ϕ}_{r}^{( 2 )} {ϕ}_{b}^{( 2 )} + {V}_{r}^{( 1 )} ( {ϕ}_{r}^{( 1 )} ) + {V}_{r}^{( 2 )} ( {ϕ}_{r}^{( 2 )} ) + {V}_{b}^{( 1 )} ( {ϕ}_{b}^{( 1 )} ) + {V}_{b}^{( 2 )} ( {ϕ}_{b}^{( 2 )} ) \qquad ( eq . 21 )$$

where ϕ_{b}⁽¹⁾ and ϕ_{b}⁽²⁾ are bias oscillators coupled to the relay oscillators. Each relay oscillator as well as the bias oscillators have their own potentials given by Vᵣ⁽¹⁾(ϕᵣ⁽¹⁾). Vᵣ⁽²⁾(ϕᵣ⁽²⁾), V_{b}⁽¹⁾(ϕ_{b}⁽¹⁾) and V_{b}⁽²⁾(ϕ_{b}⁽²⁾). The time dependent coupling parameter may be given by

$${λ}_{1} ( t ) = {λ}_{1} ( σ ( {k}_{1} ( t - {t}_{1} ) ) - σ ( {k}_{1} ( t - {t}_{2} ) ) ) . \qquad ( eq . 22 )$$

Similar to how the relay oscillator starts with a small mass times frequency prior to being coupled to the output relay oscillator in FIG. 5, ϕᵣ⁽²⁾ (i.e. the next relay oscillator) is initialized with a small mass times frequency during it's coupling with ϕᵣ⁽¹⁾. When the coupling between ϕᵣ⁽¹⁾ and ϕᵣ⁽²⁾ is turned off, the product of the mass times frequency of ϕᵣ⁽²⁾ is quickly increased in order to freeze it's position degree of freedom to effectively copy the state of ϕᵣ⁽¹⁾ onto ϕᵣ⁽²⁾. Coupling λ₁ in eq. 22 may be chosen to be large.

Note that the underlying graph structure for the Gibbs sampling algorithm shown in FIG. 6A does not have to be a tree. An example where the graph is not a tree is shown in FIG. 6B.

FIG. 6B illustrates a package of a hierarchical thermodynamic computing architecture, wherein an underlying graph has a structure other than a tree structure, according to some embodiments.

For example, package 612 shows that the underlying graph does not have a tree structure. Note that block 608a of chip 610a is coupled to block 608c (also of chip 610a) as well as block 608d of chip 610b. In general, many structures of couplings may be implemented using hierarchical architecture.

FIG. 7A illustrates relay oscillators representing visible and latent variables in a hierarchical thermodynamic computing architecture, according to some embodiments.

In some embodiments, ensemble 108 consists of one or more packages, as illustrated in FIG. 7A. Packages (e.g., package 606) within the ensemble may be coupled using multiple relay oscillators as described in FIG. 6A. Whether considering packages with PD or FD blocks, having multiple packages in an ensemble allows for greater flexibility, such as the ability to perform multiplexing. When implementing multiplexing, the ensemble can have a classical external device that allows for a tunable coupling topology (i.e. the coupling between packages may be tuned prior to implementing a learning algorithm) thus allowing for greater flexibility in the kinds of problems the ensemble can solve. The value of whether the coupling between two packages is on or off is tunable. Note that the underlying graphs used to perform Gibbs sampling in FIGS. 7A-10B are not constrained to trees. For instance, the graphs are allowed to contain cycles as in FIG. 6B.

For example, FIG. 7A illustrates visible and hidden variables in a hierarchical EBM architecture. The input thermodynamic data 702 is labelled as x_{D}. The latent variables are z=(z₁, z₂, . . . , z₇) where zᵢ contains all hidden variables in the i'th layer. For example, latent variables for layer 1 704a is represented by z₁, and latent variables for layer 2 704b is represented by z₂ and so on. The output visible neurons with output thermodynamic data on relay oscillator(s) 706 are labelled as xₒᵤₜ. The latent variables (e.g., 704a) in a given layer can further be decomposed into the outputs of each EBM block, however this is omitted in this figure to avoid cluttering.

In some embodiments, each EBM block of the hierarchical architecture described in FIGS. 2A-6B with energy functions

$${ℰ}_{{B}_{j}}^{( {θ}_{{B}_{j}} )}$$

has a set of parameters θ_{B}_{ⱼ} which can be learned. The parameters may further be denoted as θ=(θ_{B}_{₁}, . . . , θ_{B}_{_{L}}) assuming there are a total of L blocks. The total energy of the system may be a sum of each individual energy function and may be written as

$${ℰ}_{θ} = {\sum }_{j = 1}^{L} {ℰ}_{{B}_{j}}^{( {θ}_{{B}_{j}} )} , \qquad ( eq . 23 )$$

since the entire hierarchical architecture is structured such that each clamped output of an EBM block may be an input to another EBM block. Further below, a derivation of the parameter update rule is provided by computing the gradient of the log likelihood. The result is given by

$${θ}_{t + 1} = {θ}_{t} - \frac{{ϵ}_{t}}{2} N ( \text{} \frac{1}{n} {\sum }_{i = 1}^{n} {z ∼ {p}_{{θ}_{t}} ( z \vert {x}_{{t}_{i}} )}_{} [ {∇}_{{θ}_{t}} {ℰ}_{{θ}_{t}} ( {x}_{{t}_{i}} , z ) ] - {( x , z ) ∼ {p}_{{θ}_{t}} ( x , z )}_{} [ {∇}_{{θ}_{t}} {ℰ}_{{θ}_{t}} ( x , z ) ] ) + {η}_{t} . \qquad ( eq . 24 )$$

where ηₜ˜N(0, ∈ₜ) (e.g., an underlying normal distribution). Note that the first term inside the parentheses requires sampling latent variables z˜p_{θ}_{ₜ}(z|xₜ_{ᵢ}) (e.g., 704a and 704b) where xₜ_{ᵢ} is an element of the training data (which would correspond to clamping the input oscillators to the ensemble to xₜ_{ᵢ}). The second term inside the parentheses requires sampling from the joint distribution (x,z)˜p_{θ}_{ₜ}(x,z). The latent variables z are the outputs of all the EBMs apart from the input data x_{D} to the EBMs in the first layer. In some embodiments, obtaining such samples may be different when the EBMs are composed of PD as opposed to FD blocks.

In some embodiments, once the parameters for the EBM blocks have been learned, inference may be performed using the Langevin MCMC algorithm as follows

$${x}_{k + 1} = {x}_{k} - δ {z ∼ {p}_{θ} ( z \vert {x}_{k} )}_{} [ {∇}_{x} {ℰ}_{θ} ( {x}_{k} , z ) ] + \sqrt{2 δ} {ξ}_{k} \qquad ( eq . 25 )$$

as will be shown further below. Here, the labels x correspond to the outputs of the EBMs belonging to the last layer of the hierarchy (e.g., 706). Note that the Langevin MCMC may occur naturally in hardware through the Langevin dynamics of the system. For instance, the GJF method can be used to discretize the Langevin equations of motion and eq. 25 may be replaced with

$${ϕ}_{k} ( t + δ t ) = {ϕ}_{k} ( t ) + b δ t \frac{\partial {ℰ}_{θ}}{\partial {π}_{k}} {\vert}_{t} - \frac{{b ( δ t )}^{2}}{2 {m}_{k}} \frac{\partial {ℰ}_{θ}}{\partial {ϕ}_{k}} {\vert}_{t} + \frac{b {σ ( δ t )}^{3 / 2}}{2 \sqrt{{m}_{k}}} {η}_{t}^{( k )} , \qquad ( eqs . 26 - 27 )$$

$${π}_{k} ( t + δ t ) = a {π}_{k} ( t ) - \frac{δ t}{2} ( a \frac{\partial {ℰ}_{θ}}{\partial {π}_{k}} {\vert}_{t} + \frac{\partial {ℰ}_{θ}}{\partial {ϕ}_{k}} {\vert}_{t + δ t} ) + b σ \sqrt{{m}_{k} δ t} {η}_{t}^{( k )} ,$$

where ϕₖ is the position degrees of freedom of the k'th component output neuron vector xₒᵤₜ, and πₓ is the momentum degree of freedom of the k'th component. In eq. 27, σ=\sqrt{2k_{b}Tγ}, ηₜ^{(k)}˜N(0,1) and

$$a ≡ \frac{1 - γδ t / 2}{1 + γδ t / 2} b ≡ \frac{1}{1 + γδ t / 2} . \qquad ( eqs . 28 - 29 )$$

FIG. 7B illustrates a subsection of the hierarchical thermodynamic computing architecture of FIG. 7A, wherein nested Gibbs sampling is performed for a single chip of the hierarchical thermodynamic computing architecture, according to some embodiments.

In some embodiments, the samples z˜p_{θ}_{ₜ}(z|xₜ_{ᵢ}) and (x,z)˜p_{θ}_{ₜ}(x,z) may be obtained by sampling from the entire graph (i.e. the entire hierarchy of EBMs of the hierarchical architecture 100). However, the samples may also be obtained in a nested fashion. For example, partitions of package components may be used, or partitions of chip components within a package and so on. When obtaining samples in a nested fashion (e.g., nested Gibbs sampling for chip 710), the input of the nested block (e.g., input blocks for 20 chip 710) may be treated the same way the data xₜ_{ᵢ} is treated as input to the full graph. For example, the input to the indicated chip 710 is nested input thermodynamic data 712 (z₂⁽¹⁾), where z₂⁽¹⁾ is the output of previous EBM blocks. Furthermore, nested latent variables 714 may be represented by z₃⁽¹⁾ and nested output thermodynamic data 716 may be represented by z₄⁽¹⁾. To obtain samples from both distributions in eq. 24, the oscillators with input thermodynamic data 712 (z₂⁽¹⁾) are clamped and is treated the same way in the Gibbs sampling algorithm when applied to the highlighted chip as input data is treated for performing the Gibbs sampling algorithm on the entire hierarchical architecture. Then the oscillators with thermodynamic data z₂⁽¹⁾ is un-clamped and again Gibbs sampling algorithm may be performed in that case. The specific sampling algorithms for both the joint and conditional distributions are described in FIG. 8-10B. Some of the advantages of performing nested Gibbs sampling are parallelization (e.g., ability to parallelize across subsets of the graph or across different devices); heterogeneity (e.g., ability to parallelize across different device types. For instance, a device may contain both PD and FD blocks); asynchronicity (e.g., ability to parallelize workloads and do a global algorithm without the need for a synchronous global clock; and time scale separation hierarchy (e.g., ability to have certain variables be sampled more often than others.

FIG. 8A illustrates measurement results for relay oscillators of a hierarchical thermodynamic computing architecture being provided to an FPGA/ASIC chip, wherein the measurement results may be used to perform parameter update rules, according to some embodiments.

In some embodiments, measurement results of a relay oscillator may be sent to an FPGA/ASIC chip to perform the parameter update rules of eq. 24. For illustration, arrows from a package to the FPGA/ASIC chip 804 located in compute environment 802 (e.g., a dilution refrigerator) indicate that the measurement result of each relay oscillator in a given package is sent to the FPGA/ASIC chip 804. The FPGA/ASIC chip 804 may also be located outside a compute environment, and there may be multiple compute environments, with measurement results of the relay oscillators in each compute environment being sent to the FPGA/ASIC chip 804.

In what follows, a sampling algorithm is described for the entire graph. However, the same algorithm can also be applied to any nested subgraph by treating the inputs for the nested subgraph in the same way as the input data to the entire graph.

For example, an ensemble architecture containing packages as in hierarchical architecture 100 may be used. Samples may be obtained to implement eq. 24 in hardware with either PD or FD EBM blocks. To implement eq. 24, sample may be obtained from the conditional distribution z˜p_{θ}_{ₜ}(z|xₜ_{ᵢ}) as well as the joint distribution (x, z)˜p_{θ}_{ₜ}(x, z).

A process may start with the conditional distribution with the input data clamped to xₜ_{ᵢ}. Suppose that the output oscillators of a given EBM are clamped. In some embodiments, a directed graph may be used, wherein the oscillators may be clamped and given the layered structured of the graph for the entire ensemble 108. As such, the conditional distribution may be written as

$${p}_{{θ}_{t}} ( z \vert {x}_{{t}_{i}} ) = {p}_{{θ}_{t}} ( {z}_{1} \vert {x}_{{t}_{i}} ) {\prod }_{k} {p}_{{θ}_{t}} ( {z}_{k} \vert {z}_{k - 1} ) , \qquad ( eq . 30 )$$

where z=(z₁, . . . , z_{N}) as in FIG. 7A. Now, let z_{B}_{ⱼ}⁽ⁱ⁾ be the clamped outputs of the EBM ε_{B}_{ⱼ}^{(θB}^{_{B}}⁾ in the first layer, and z₁=(z_{B}_{₁}⁽¹⁾, . . . , z_{B}_{_{K}}⁽¹⁾) where it may be assumed there are K blocks. By definition, z₁˜p_{θ}_{ₜ}(z₁|xₜ_{ᵢ}). Given a clamped z₁, the outputs from all EBMs in the second layer will be sampled from z₂˜p_{θ}_{ₜ}(z₂|z₁). This may continue until all layers of the graph have been covered.

In some embodiments, samples may be obtained from a joint distribution which is given by

$${p}_{{θ}_{t}} ( x , z ) = {p}_{{θ}_{t}} ( x ) {p}_{{θ}_{t}} ( {z}_{1} \vert x ) {\prod }_{k} {p}_{{θ}_{t}} ( {z}_{k} \vert {z}_{k - 1} ) . \qquad ( eq . 31 )$$

The input neurons representing the vector x may evolve for some time, after which their values are clamped. Given a clamped x, the same algorithm used for sampling from the conditional distribution p_{θ}_{ₜ}(z|xₜ_{ᵢ}) may be implemented. This protocol is known as the forwards pass (e.g., see forwards pass 902 or 1002. Given all the clamped z neurons, the input neurons x evolve, effectively sampling from p_{θ}_{ₜ}(x|z). This is known as the backwards pass (e.g., see backwards pass 904 or 1004). The forwards and backwards passes may be repeated multiple times until convergence.

FIG. 8B illustrates a pipeline for parameter updates for a hierarchical thermodynamic computing architecture, wherein some parameter update computations may be performed on classical computing devices and other parameter update computations may be performed using thermodynamic processors, according to some embodiments.

In some embodiments, for a pipeline formalism, parts of the full computation may be done on an FPGA/ASIC chip 806 or 808 (e.g., sampling from EBM blocks and the full Gibbs sampling algorithm is done in software), and other parts on thermodynamic processors. The Gibbs sampling algorithm on the thermodynamic processor works the same way as in FIG. 8A, but the input to the ensemble is computed from the sampling operations performed on the FPGA/ASIC chip 806.

In FIG. 8B an example of the pipeline formalism is given. In general, a Gibbs sampling computation of an underlying graph may be performed across multiple devices, some of which may be thermodynamic processors on an ensemble, and others which may be classical devices which implement the Gibbs sampling algorithm in software for parts of the graph.

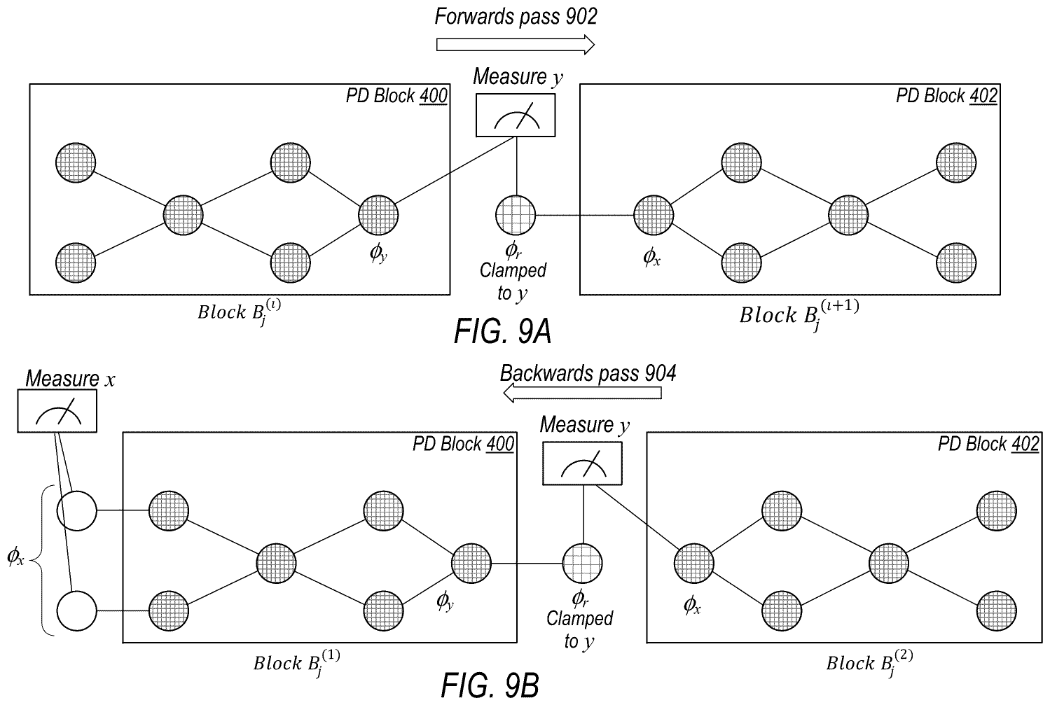

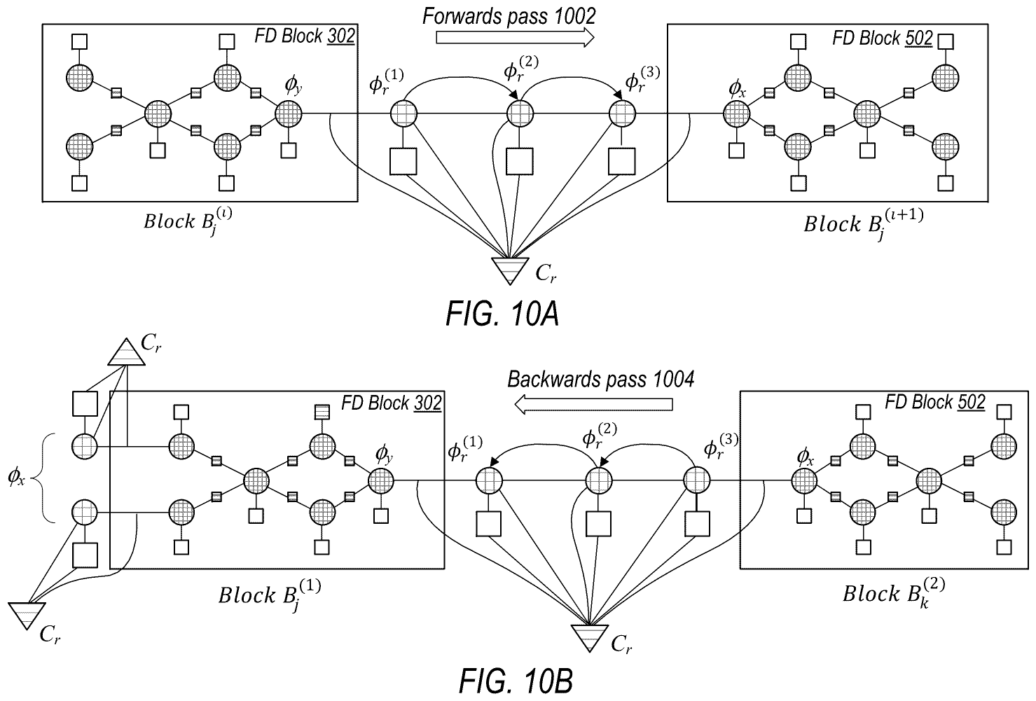

In some embodiments, samples are obtained from software on an FPGA/ASIC chip, and such samples must be used in other parts of a larger underlying graph which is implemented on a different device. If the device is another ASIC/FPGA, the inputs may be clamped, using software, to the values obtained from the previous FPGA/ASIC chip. Now if the device is a thermodynamic processor, the samples computed on an FPGA would then be clamped to position degrees of freedom of harmonic oscillators, which would be treated the same way input data was used to obtain the relevant samples in FIGS. 9A-10B. The Gibbs sampling algorithm may be treated as a nested Gibbs sampling algorithm. If the sampled outputs of the thermodynamic processor are then used as inputs to another thermodynamic processor or FPGA/ASIC, the sampled outputs may be measured, and the inputs may be initialized on the other device either in software or clamping the state to the input oscillators of the next device.

FIG. 9A illustrates a forwards pass of Gibbs sampling using partially dynamical (PD) blocks, wherein a relay oscillator is clamped to measured output thermodynamic data of a PD block, according to some embodiments.

In some embodiments, a hierarchical architecture may perform a forwards pass 902. For example, the output neuron of the PD block 400 (block Bₗ⁽ⁱ⁾) may be measured to be y. Further, suppose the output of block Bₗ^{(l)} is coupled to the input of PD block 402 (block Bₖ^{(l+1)} using a relay oscillator with position degree of freedom ϕᵣ. In this case, ϕᵣ is clamped to y and then coupled to ϕₓ with is an input oscillator for the block Bₖ^{(l+1)}.

In some embodiments, in a forwards pass 902, samples may be obtained corresponding to p_{θ}_{ₜ}(z|xₜ_{ᵢ}), where xₜ_{ᵢ} represents the input data (with the input neurons clamped to xₜ_{ᵢ} through the protocol). Given how p_{θ}_{ₜ}(z|xₜ_{ᵢ}) factorizes in eq. 30 due to the layered directed graph of the ensemble 108, EBM blocks where the output of one block is coupled to the input of a block in a subsequent layer through a relay oscillator may be considered. Consider the j'th PD EBM block in the l'th layer which may be labeled as Bⱼ^{(l)}. Samples may be obtained from

$${z}_{{B}_{j}^{( l )}} ∼ {p}_{{θ}_{t}} ( {z}_{{B}_{j}^{( l )}} \vert {\prod }_{k} {z}_{{B}_{k}^{( l - 1 )}} )$$

where Bₖ^{(l-1)} represents all EBM blocks with outputs which are coupled to the inputs of the block Bⱼ^{(l)} through a relay oscillator. Such a sample may be obtained by measuring the output neurons of the block Bⱼ^{(l)} and clamping the relay oscillator which acts as input to a subsequent EBM block to the measured value. The clamping can be done using a potential for the relay oscillator as described in eq. 15. The above steps may be repeated for all subsequent blocks in the l'th layer, resulting in p(zₗ|zₗ₋₁). Using the measured output values as inputs for the next layer through the clamped relay oscillators, the above steps may be repeated for all subsequent layers. The accumulation of all measured outcomes will thus correspond to samples from p_{θ}_{ₜ}(z|xₜ_{ᵢ}). Such measured values are then sent to an FPGA/ASIC chip 804 as in FIG. 8A. To get multiple samples to compute the expectation value for the term

$${z ∼ {p}_{{θ}_{t}} ( z \vert {x}_{{t}_{i}} )}_{} [ {∇}_{{θ}_{t}} {ℰ}_{{θ}_{t}} ( {x}_{{t}_{i} ,} z ) ]$$

in eq. 24 on the FPGA/ASIC chip 804, the above steps may be repeated with the input neurons clamped to the same value, each time initializing all other neurons from some prior distribution (e.g., prior sampled values).

FIG. 9B illustrates a backwards pass of Gibbs sampling using partially dynamical (PD) blocks, wherein thermodynamic data of input oscillators are measured, according to some embodiments.

In some embodiments, for a backwards pass 904, the measured outputs in the very last layer which were obtained during the forward pass remain clamped. Then the input neurons of the EBMs connected to the final layer may be sampled, and the input relay oscillators may be clamped to the measured values, which then act as the output of the EBM in the next (leftmost) layer. This may continue until the neurons ox representing the input layer are reached. The final measured value of x is sampled from p_{θ}_{ₜ}(x|z) where z includes the newly sampled values during the backwards pass. For a general layered graph, the forwards and backwards pass may be repeated multiple times before sending the measured samples to the FPGA/ASIC chip 804.

In some embodiments, samples from the joint distribution p_{θ}_{ₜ}(x, z) may be obtained using forwards and backwards passes. The forwards pass 902 is achieved using the same protocol to obtain the samples from p_{θ}_{ₜ}(z|xₜ_{ᵢ}) as described above, except that x may be randomly initialized according to some prior distribution. let z_{L}_be the samples obtained during the forward pass 902 in the final layer. Now, to perform the backwards pass 904 to obtain samples of p_{θ}_{ₜ}(x|z), samples of z_{L-1} may be obtained in the L−1'th layer, with the outputs of the EBM clamped to z_{L}. The input relay oscillators are then clamped to the measured values. This may continue until the input neurons are reached. Measuring the position degrees of freedom of the input neurons will then correspond to obtaining samples from p_{θ}_{ₜ}(x|z) where z, where z=(z₁, . . . , z_{L}) correspond to the new samples obtained during the backwards pass (except for z_{L} since these remain clamped to the values obtained during the forward pass).

Note that if the graph corresponds to a tree, only one forwards and one backwards pass to may be used to sample from p_{θ}_{ₜ}(x, z). However, for more general layered graphs, multiple sets of forwards followed by backwards passes may be performed. For instance, if after the first backwards pass another forwards pass is require, x would be clamped to the values obtained during the previous backwards pass, and then the same forwards pass algorithm as described above would be used, followed by the same backwards pass algorithm.

Once all the samples for p_{θ}_{ₜ}(z|xₜ_{ᵢ}) and p_{θ}_{ₜ}(x,z) are sent to the FPGA/ASIC chip 804, the FPGA/ASIC chip 804 may perform the parameter update of eq. 24. After the parameters are updated, the protocol described in this section begins anew until convergence, or the desired training accuracy is achieved.

FIG. 10A illustrates a forwards pass of Gibbs sampling using fully dynamical (FD) blocks, wherein a relay oscillator is clamped to output oscillators of a FD block, according to some embodiments.

In some embodiments, a forwards pass 1002 may be performed with FD EBM blocks. For example, a relay oscillator ϕᵣ⁽¹⁾ is coupled to the output relay oscillator ϕ_{y} from the block Bⱼ^{(l)} as described in FIG. 5. The coupling effectively freezes the output state to a sampled value due to the increase of the mass times frequency of ϕᵣ⁽¹⁾ and large coupling strength (with the coupling being turned on rapidly). The relay oscillator ϕᵣ⁽¹⁾ is then coupled to subsequent relay oscillators (if for instance Bₖ^{(l+1)} belongs to a different chip or package) in the chain until the final relay oscillator is reach and coupled to the input neurons of the block Bₖ^{(l+1)} in a subsequent layer.

In some embodiments, samples may be obtained for FD blocks. The relay oscillator gadget used for FD blocks is fully analogue, as described in FIG. 5. The parameters θ are dynamical parameters and initialized to the last computed value on the FPGA/ASIC chip in eq. 24 (or according to some prior distribution at the beginning of the protocol). For example, gradients may be obtained using samples from the conditional distribution p_{θ}_{ₜ}(z|xₜ_{ᵢ}) for the positive phase of the update rule. Similar to FIGS. 9A-9B for PD blocks, consider the j'th FD block in the l'th layer which may be labeled as Bⱼ^{(l)}. To sample from

$${z}_{{B}_{j}^{( l )}} ∼ {p}_{{θ}_{t}} ( {z}_{{B}_{j}^{( l )}} \vert {\prod }_{k} {z}_{{B}_{k}^{( l - 1 )}} ) ,$$

the coupling between the relay oscillators and the output neurons of Bis quickly turned on, effectively freezing the output neuron and bias oscillator to a particular sample by also quickly increasing the mass time frequency of the relay oscillator and coupling it to a bias (see FIG. 5). During the coupling between the relay oscillator and the output neuron, either the position or momentum of the synapse oscillators in the block Bⱼ^{(l)} may be measured. Such a measurement provides a gradient of the form

$${∇}_{{θ}_{t}} {ε}_{{θ}_{t}}^{( {B}_{j}^{( l )} )} ( {z}_{{B}_{j}^{( l )}} , {\prod }_{k} {z}_{{B}_{k}^{( l - 1 )}} )$$

where

$${z}_{{B}_{k}^{( l - 1 )}}$$

are the inputs to the FD EBM block Bⱼ^{(l)}, and

$${z}_{{B}_{j}^{( l )}}$$

are its outputs. The coupling with the relay oscillator is chosen to ensure that the output neurons remain clamped to

$${z}_{{B}_{j}^{( l )}}$$

during the measurements of the synapses. The same steps may be performed for all other EBM blocks in the given layer resulting in the sample p(zₗ|zₗ₋₁). Now if multiple relay oscillators are needed to couple the output of the block Bⱼ^{(l)} to the input of another block Bₖ^{(l+1)} for some k, the state transfer protocol may be repeated between all subsequent relay oscillators, as was explain in FIGS. 6A-6B. When the final relay oscillator (in a chain of relay oscillators) is used as input to the block Bₖ^{(l+1)}, it remains clamped to

$${z}_{{B}_{j}^{( l )}} .$$

Note that for FD blocks, samples of the output neurons are never directly measured. Instead, their state is transferred across all necessary relay oscillators until it is the input for the next EBM FD block. What is measured and sent to the FPGA/ASIC chip are the gradients (such as

$${∇}_{{θ}_{t}} {ℰ}_{{θ}_{t}}^{( {B}_{j}^{( l )} )} ( {z}_{{B}_{j}^{( l )}} , {\prod }_{k} {z}_{{B}_{k}^{( l - 1 )}} )$$

described above). One of the advantages of the FD protocol over the PD protocol is that gradients rather than samples are obtained directly, thus reducing the amount of computations needed to be performed on the FPGA/ASIC chip. Further, the relay oscillator implementation is used in a fully analogue way.

The above protocol may be repeated for all blocks in each layer of the graph until blocks in the final layers have been reached. Each synapse measurement thus results in a gradient needed to compute

$${z ∼ {p}_{{θ}_{t}} ( z \vert {x}_{{t}_{i}} )}_{} [ {∇}_{{θ}_{t}} {ℰ}_{{θ}_{t}} ( {x}_{{t}_{i}} , z ) ]$$

in eq. 24. To obtain multiple samples needed to compute the expectation value in the term

$${z ∼ {p}_{{θ}_{t}} ( z \vert {x}_{{t}_{i}} )}_{} [ {∇}_{{θ}_{t}} {ℰ}_{{θ}_{t}} ( {x}_{{t}_{i}} , z ) ] ,$$

the above protocol may be repeated, with the same input data, and at each repetition all other neurons are randomly initialized according to some prior distribution.

FIG. 10B illustrates a backwards pass of Gibbs sampling using fully dynamical (FD) blocks, wherein a relay oscillator is clamped to input oscillators of a FD block, according to some embodiments.

In some embodiments, backwards pass 1004 may utilize a similar protocol as the forwards pass 1002 but in the reverse direction. For example, the final z_{L} values clamped in the last layer of the graph are clamped as outputs of the EBMs in the last layer L. Then the inputs may evolve, and the relay oscillator methods in reverse may be used to propagate backwards until the first layer is reached, wherein the input neurons are clamped using additional relay and bias oscillators.

In some embodiments, gradients may be obtained using samples from the joint distribution p_{θ}_{ₜ}(x, z) for the negative phase of the parameter update rule. To sample from p_{θ}_{ₜ}(x, z), all neurons may be initialized, including the input neurons, according to some prior distribution. The forward pass 1002 to obtain gradients from a sample p_{θ}_{ₜ}(z|x) is done using the same steps as described above to obtain gradients sampled from p_{θ}_{ₜ}(z|xₜ_{ᵢ}), where the input neurons are clamped to some initialized value from the prior distribution. A relay oscillator and bias oscillator may be used to clamp the input neurons in the same way that these are used to clamp the output neurons of all subsequent blocks. Note however that during the forward pass 1002, the gradients in the FD EBM blocks don't need to be measured since the samples are not yet from the joint distribution (at least one backwards pass 1004 may need to be performed, and only one backwards pass 1004 if the graph is a tree).

In some embodiments, a backwards pass 1004 works in an identical fashion as the forwards pass 1002, except that the output neurons z_{L} in the final layer L remain clamped using the relay oscillator, and the neurons in the layer L−1 may evolve before clamping them with relay oscillators, possibly transferring their state to other relay oscillators which then act as clamped outputs for EBM blocks in layer L−2 and so on. These steps may be repeated until the input neurons in the first layer are reached, which are allowed to evolve for some time with outputs zₗ clamped. After which the input neurons may be clamped using relay and bias oscillators. An illustrative example of a subset of EBM blocks during the backwards pass 1004 is shown in FIG. 10B. Note that if the graph is not a tree, multiple forwards and backwards passes may be implemented, where any additional forwards passes 1002 uses clamped x neurons obtained from the previous backwards pass 1004. The position or momentum degrees of freedom of the synapses in each EBM block may be measured during the final backwards pass. Such gradients then correspond to sampled gradients from the joint distribution.

After obtaining gradients sampled from p_{θ}_{ₜ}(z|xₜ_{ᵢ}) and p_{θ}_{ₜ}(x, z), the FPGA/ASIC chip 804 may implement eq. 24 to update the synapses of each EBM block. The above protocol for obtaining sampled gradients from p_{θ}_{ₜ}(z|xₜ_{ᵢ}) and p_{θ}_{ₜ}(x, z) begins anew until the desired training accuracy is achieved.

Note that in some embodiments, a gradient update rule for an EBM in the presence of latent (hidden) variables may be derived in the following manner. First, the probability distribution is given by

$${p}_{θ} ( x , z ) = \frac{{e}^{- {ℰ}_{θ} ( x , z )}}{Z ( θ )} , \qquad ( eq . 32 )$$

where

$$Z ( θ ) = {\sum }_{x , z} {e}^{- {ℰ}_{θ} ( x , z )}$$

is partition function, θ are the models parameters, and ε_{θ}(x, z) is the energy function. The visible variables may be labeled as x and the variables as z.

The Welling and Teh update rule is obtained by taking the gradient with respect to the parameters of the log-likelihood and is represented by

$${θ}_{t + 1} = {θ}_{t} + \frac{{ϵ}_{t}}{2} ( \frac{N}{n} {\sum }_{i = 1}^{n} {∇}_{{θ}_{t}} log {p}_{{θ}_{t}} ( {x}_{{t}_{i}} ) ) + {η}_{t} , \qquad ( eq . 33 )$$

where xₜ_{ᵢ} is an element of the data set. Now, the probability p_{θ}(x) is obtained by marginalizing over the latent variables

$${p}_{θ} ( x ) = {\sum }_{z} {p}_{θ} ( x , z ) = \frac{Z ( θ , x )}{Z ( θ )} , \qquad ( eq . 34 )$$

where the last equality comes from the fact that

$$\frac{Z ( θ , x )}{Z ( θ )} = \frac{{\sum }_{z} {e}^{- {ℰ}_{θ} ( x , z )}}{{\sum }_{z , x} {e}^{- {ℰ}_{θ} ( x , z )}} . \qquad ( eq . 35 )$$

Now, calculating the gradient of the log-likelihood evaluated at an element xₙ, may result in

$$\begin{matrix}{∇}_{θ} log {p}_{θ} ( {x}_{n} ) = {∇}_{θ} log {\sum }_{z} {p}_{θ} ( {x}_{n} , z ) \\ = \frac{1}{{\sum }_{z} {p}_{θ} ( {x}_{n} , z )} {\sum }_{z} {∇}_{θ} {p}_{θ} ( {x}_{n} , z ) \\ = \frac{Z ( θ )}{Z ( θ , {x}_{n} )} {∇}_{θ} {\sum }_{z} {p}_{θ} ( {x}_{n} , z ) \\ = \frac{Z ( θ )}{Z ( θ , {x}_{n} )} {\sum }_{z} ( - {∇}_{θ} {ℰ}_{θ} ( {x}_{n} , z ) \frac{{e}^{- {ℰ}_{θ} ( {x}_{n} , z )}}{Z ( θ )} - \frac{{e}^{- {ℰ}_{θ} ( {x}_{n} , z )}}{{Z ( θ )}^{2}} {∇}_{θ} Z ( θ ) ) \\ = {\sum }_{z} ( - {∇}_{θ} {ℰ}_{θ} ( {x}_{n} , z ) {p}_{θ} ( z \vert {x}_{n} ) - \frac{{p}_{θ} ( {x}_{n} , z )}{Z ( θ , {x}_{n} )} {\sum }_{x , z} \frac{{∇}_{θ} {e}^{- {ℰ}_{θ} ( x , z )}}{Z ( θ )} ) \\ = - {z ∼ {p}_{θ} ( z \vert {x}_{n} )}_{} [ {∇}_{θ} {ℰ}_{θ} ( {x}_{n} , z ) ] + {( x , z ) ∼ {p}_{θ} ( x , z )}_{} [ {∇}_{θ} {ℰ}_{θ} ( x , z ) ]\end{matrix} \qquad ( eq . 36 )$$

In going from the second last to the last line, the following is used

$${\sum }_{z} \frac{{p}_{θ} ( {x}_{n} , z )}{Z ( θ , {x}_{n} )} = 1 \qquad ( eq . 37 )$$

$$and$$

$${∇}_{θ} {\sum }_{x , z} \frac{{e}^{- {ℰ}_{θ} ( x , z )}}{Z ( θ )} = - {\sum }_{x , z} {∇}_{θ} {ℰ}_{θ} ( x , z ) {p}_{θ} ( x , z ) \qquad ( eq . 38 )$$

Inserting eq. 36 in eq. 33, results in

$${θ}_{t + 1} = {θ}_{t} - \frac{{ϵ}_{t}}{2} N ( \frac{1}{n} {\sum }_{i = 1}^{n} {z ∼ {p}_{{θ}_{t}} ( z \vert {x}_{i} )}_{} [ {∇}_{{θ}_{t}} {ℰ}_{{θ}_{t}} ( {x}_{{t}_{i}} , z ) ] - {( x , z ) ∼ {p}_{{θ}_{t}} ( x , z )}_{} [ {∇}_{{θ}_{t}} {ℰ}_{{θ}_{t}} ( x , z ) ] ) + {η}_{t} . \qquad ( eq . 39 )$$

Note that in some embodiments, inference may be performed with latent variables. The Langevin MCMC algorithm allows sample of x from the distribution p_{θ}(x). In the presence of latent variables, the Langevin MCMC update rules becomes

$$\begin{matrix}{x}_{k + 1} = {x}_{k} + δ {∇}_{x} log {p}_{θ} ( {x}_{k} ) + \sqrt{2 δ} {ξ}_{k} \\ = {x}_{k} + δ {∇}_{x} {\sum }_{z} log {p}_{θ} ( {x}_{k} , z ) + \sqrt{2 δ} {ξ}_{k} \\ = {x}_{k} + δ ( \frac{{∇}_{x} Z ( θ , {x}_{k} )}{Z ( θ , {x}_{k} )} ) + \sqrt{2 δ} {ξ}_{k} \\ = {x}_{k} - δ ( {\sum }_{z} \frac{exp ( - {ℰ}_{θ} ( {x}_{k} , z ) )}{Z ( θ , {x}_{k} )} {∇}_{x} {ℰ}_{θ} ( {x}_{k} , z ) ) + \sqrt{2 δ} {ξ}_{k} \\ = {x}_{k} - δ {z ∼ {p}_{θ} ( z \vert {x}_{k} )}_{} [ {∇}_{x} {ℰ}_{θ} ( {x}_{k} , z ) ] + \sqrt{2 δ} {ξ}_{k}\end{matrix} \qquad ( eq . 40 )$$

with the random variable ξₖ˜N(0,I).

FIG. 11 illustrates a flowchart that describes performing Gibbs sampling using hierarchical architecture, according to some embodiments.

At block 1100, an energy based model (EBM) may be implemented using one or more oscillators and couplings between oscillators. An EBM may correspond to a block of a hierarchical architecture, wherein Gibbs sampling (or more generally, sampling) may be performed on the entire hierarchical architecture or a subset of blocks of EBMs (e.g., nested sampling). Oscillators may be constructed using superconducting elements or other suitable resonators that approximately behave as an oscillator. Coupling between oscillators may be engineered to form an engineered potential, wherein the oscillators may evolve according to the engineered potential.

At block 1102, oscillators of the blocks of EBMs may be initialized to thermodynamic data from a prior thermodynamic evolution. Thermodynamic data may include position, momentum, or force related to the thermodynamic data. Oscillators of an EBM block may represent neurons and others may represent synapses (e.g., weights and biases) for a thermodynamically implemented neural network. In some embodiments, synapses are configured in hardware and are not represented by oscillators.

At block 1104, relay oscillators may be used to relay thermodynamic data from one EBM block to another EBM block. The EBM blocks may be blocks within the same chip or within different chips. Relay oscillators are oscillators with adjustable masses and frequencies. A relay oscillator may obtain thermodynamic data from a first EBM block via coupling with output oscillators of the EBM block or by implementing a measured thermodynamic data value in hardware. A product of mass and frequency squared of the relay oscillator(s) may be increased by adjusting the masses and/or frequencies of the relay oscillator(s). Thus, the relay oscillator may be clamped to a thermodynamic data it is initiated to.

At block 1106, one or more thermodynamic evolutions may be performed wherein oscillators may thermodynamically adjust to an evolved state. For example, given input information to a first EBM block, a sample may be obtained from an evolved oscillator (e.g., an evolved output oscillator, a relay oscillator coupled to the output oscillator, or a synapse oscillator). Thermodynamic data from a prior thermodynamic evolution evolves to become evolved thermodynamic data. Thus, an effect of altering input data may be measured.

At block 1108, the evolved thermodynamic data may be measured or otherwise obtained (e.g., via another oscillator) to obtain a sampling that corresponds to a Gibbs sampling value. The Gibbs sampling value may be used in a plurality of applications such as parameter training and inference generation for a neural network.

In some embodiments, samples obtained from the relay oscillators may be used to perform the parameter update rule of eq. 24. The samples are obtained from hardware, by letting the relay oscillators reach thermal equilibrium. Gibbs sampling can be used in software to obtain samples from the probability distributions p_{θ}_{ₜ}(z|xₜ_{ᵢ}) and p_{θ}_{ₜ}(z,x). That is, instead of having a physical device where samples are obtained after reaching thermal equilibrium, the samples may be obtained in software, where each EBM block is implemented in software.

For example, a number N of EBM blocks may have input data [symbol] . Samples may be obtained from the probability distribution p(z| [symbol] ), where z is the vector of outputs of each block (where in a hardware implementation these would be encoded in the state of the block relay oscillators). In the case of a directed graph, each input to an EBM block is clamped (either to the input data or to the output of a previous EBM block coupled to the current EBM block). For an un-directed graph, the inputs of an EBM block are un-clamped, apart from the input data [symbol] .

Samples from p(z| [symbol] ) can be obtained from the output neurons of each block, starting with blocks coupled to the input data in the ensemble, all the way to blocks in the final packages. The protocol is described below. In doing so, blocks may be divided into layers. Suppose there are a total of L layers. In the first layer, all blocks are coupled to elements of the data [symbol] . If there are n₁ blocks in the first layer, each block may be labeled as B₁⁽¹⁾, . . . ,

$${B}_{{n}_{2}}^{( 1 )} .$$

The next layer contains blocks whose input relay oscillators are coupled to blocks in the first layer. If there are n₂ blocks in the second layer, such blocks may be labeled as B₁⁽²⁾, . . . ,

$${B}_{{n}_{2}}^{( 2 )} .$$

In general, blocks in the l'th layer have input relay oscillators which are coupled to output relay oscillators in blocks belonging the the (l−1)'th layer. If there are nᵢ blocks in layer l, they may be labeled as B₁^{(l)}, . . . ,

$${B}_{{n}_{l}}^{( l )} .$$

An algorithm for sampling from p(z| [symbol] ) may include the following steps.
Step 1: Initialize all the neurons in each EBM block according to some prior distribution. The prior distribution can be chosen to be

$$p = \frac{{e}^{- β V ( {ϕ}_{{r}_{j}} )}}{z}$$

for a relay oscillator with a potential energy function given by V (ϕᵣ_{ⱼ}). However some other prior distribution may be used.
Step 2: Simulate the outputs of each EBM block (for instance, using MCMC). For a directed graph, sample

$${z}_{{B}_{j}^{( 1 )}} ∼ p ( {z}_{{B}_{j}^{( 1 )}} \vert {x}_{𝒟} , mb ( {z}_{{B}_{j}^{( 1 )}} ) )$$

for all j∈{1, . . . , n₁} for all j∈{1, . . . , n₁}, where mb

$$( {z}_{{B}_{j}^{( 1 )}} )$$

is the Markov blanket of

$${z}_{{B}_{j}^{( 1 )}} .$$

That is, the nodes in mb

$$( {z}_{{B}_{j}^{( 1 )}} )$$

are clamped. If the graph is un-directed, such samples correspond to

$${z}_{{B}_{j}^{( 1 )}} ∼ p ( {z}_{{B}_{j}^{( 1 )}} \vert {x}_{𝒟} , 𝒩 ( {z}_{{B}_{j}^{( 1 )}} ) )$$

where

[symbol]

$$( {z}_{{B}_{j}^{( 1 )}} )$$

corresponds to the neighbors of the nodes

$${z}_{{B}_{j}^{( 1 )}} .$$

Step 3: for each k in 2 to L do step 4.
Step 4: Simulate the outputs of each EBM block (for instance, using MCMC). For a directed graph, sample

$${z}_{{B}_{j}^{( k )}} ∼ p ( {z}_{{B}_{j}^{( k )}} \vert {x}_{D} , mb ( {z}_{{B}_{j}^{( k )}} ) )$$

for all j∈{1, . . . , nₖ}, where mb

$$( {z}_{{B}_{j}^{( k )}} )$$

is the Markov blanket of

$${z}_{{B}_{j}^{( k )}} .$$

That is, the nodes in mb

$$( {z}_{{B}_{j}^{( k )}} )$$

are clamped. If the graph is un-directed, such samples correspond to

$${z}_{{B}_{j}^{( k )}} ∼ p ( {z}_{{B}_{j}^{( k )}} \vert {x}_{D} , 𝒩 ( {z}_{{B}_{j}^{( k )}} ) )$$

where

[symbol]

$$( {z}_{{B}_{j}^{( k )}} )$$

corresponds to the neighbors of the nodes

$${z}_{{B}_{j}^{( k )}} .$$

Step 5: End for loop of step 3.
Step 6: Repeat steps 2-5 until convergence.

In the algorithm above, the Markov blanket may be used for the clamped nodes when the graph is a directed graph. By definition, the Markov blanket mb(i) is the smallest set of nodes that renders node i conditionally independent from all other nodes in the graph corresponding to the hierarchical EBM architecture. The Markov blanket mb

$$( {z}_{{B}_{j}^{( k )}} )$$

corresponds to the parents of

$${z}_{{B}_{j}^{( k )}} ,$$

the children of

$${z}_{{B}_{j}^{( k )}}$$

and the other parents of the children of

$${z}_{{B}_{j}^{( k )}} .$$

This set effectively shields

$${z}_{{B}_{j}^{( k )}}$$

from the rest of the graph. In the case of an un-directed graph, mb

$$( {z}_{{B}_{j}^{( k )}} )$$

is replaced by the neighbor

$${z}_{{B}_{j}^{( k )}}$$

since

$${z}_{{B}_{j}^{( k )}}$$

is conditionally independent from non-neighboring nodes, given its immediate neighbors. The neighbors of

$${z}_{{B}_{j}^{( k )}}$$

may be denoted as

[symbol]

$$( {z}_{{B}_{j}^{( k )}} ) .$$

A protocol for sampling from the distribution p(z, x) is very similar to the one shown in the algorithm above except that x is now treated in an identical way as the

$${z}_{{B}_{j}^{( k )}}$$

variables, and is initialized according to some prior distributions.

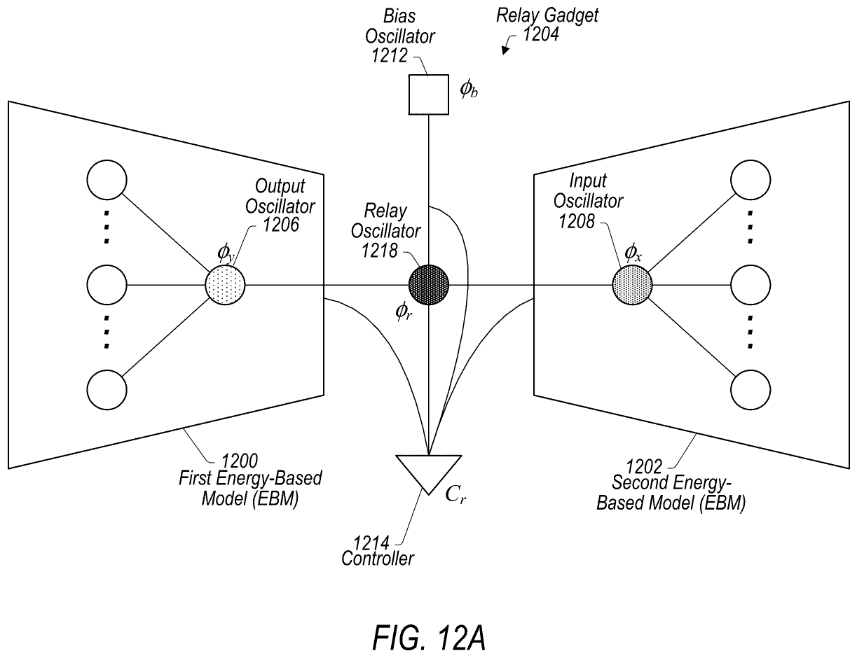

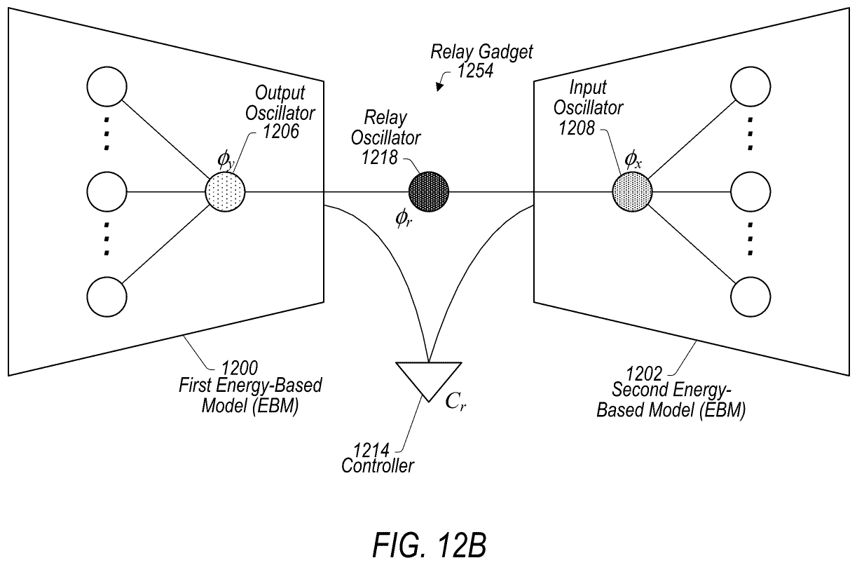

FIG. 12A illustrates additional details of a relay gadget implemented using a thermodynamic processor, wherein the relay gadget is configured to relay thermodynamic information between a first energy-based model (EBM) and a second energy-based model (EBM), such as an analog Swish gadget, according to some embodiments.

For example, FIG. 12A is high-level diagram illustrating a first energy-based model (EBM) implemented using a thermodynamic processor, a second energy-based model (EBM) implemented using a thermodynamic processor, and a relay gadget implemented using a thermodynamic processor, wherein the relay gadget is configured to relay thermodynamic information between the first energy-based model (EBM) and the second energy-based model (EBM), according to some embodiments.

In some embodiments, a relay oscillator gadget, such as relay oscillator gadget 1218, receives thermodynamic information from an input source, such as oscillator 1206, and relays the thermodynamic information to an output destination, such as oscillator 1208. In some embodiments, the oscillator 1206 may be an output oscillator 1206 of a first energy-based model (EBM) 1200 (e.g., a block of a hierarchical architecture) and the oscillator 1208 may be an input oscillator 1208 of a second energy-based model (EBM) 1202 (e.g., a next block of a hierarchical architecture). In some embodiments, the thermodynamic information being relayed from the output oscillator 1206 to the input oscillator 1208 may be a position degree of freedom. As such, FIG. 12A shows an output position degree of freedom (ϕ_{y}) of the output oscillator 1206 and an input position degree of freedom (ϕₓ) of the input oscillator 1208, as well as a relay position degree of freedom (ϕᵣ) of the relay oscillator 1218 and a bias position degree of freedom (ϕ_{b}) of the bias oscillator 1212. Additionally, controller 1214 is shown, which may be an on-chip controller. Controller 1214 causes pulses to be emitted in a time dependent manner to orchestrate coupling of the relay oscillator 1218 to the output oscillator 1206, coupling of the relay oscillator 1218 to the bias oscillator 1212, adjustment of a mass or frequency of the relay oscillator 1218, and a coupling of the relay oscillator 1218 to the input oscillator 1208. In some embodiments, the controller 1214 may be pre-programmed to emit the relevant pulses and control signals in a time dependent sequence in order to execute a relay operation.

An example Hamiltonian of the coupled system shown in FIG. 12A is given by:

$${H}_{fan} = \frac{{π}_{r}^{2}}{2 {m}_{r} ( t )} + \frac{{π}_{y}^{2}}{2 {m}_{y}} + \frac{{π}_{x}^{2}}{2 {m}_{x}} + \frac{{π}_{b}^{2}}{2 {m}_{b}} + \frac{1}{2} {m}_{r} ( t ) {ω}_{r}^{2} ( t ) {ϕ}_{r}^{2} + \frac{1}{2} {m}_{b} {ω}_{b}^{2} {ϕ}_{b}^{2} + \frac{1}{2} {m}_{y} {{ω}_{y}^{2} ( {ϕ}_{y} - {y}_{e} )}^{2} + \frac{1}{2} {m}_{x} {ω}_{x}^{2} {ϕ}_{x}^{2} + {λ}_{A} ( t ) {( {ϕ}_{y} - {ϕ}_{r} )}^{2} + {λ}_{B} ( t ) {ϕ}_{b} {ϕ}_{r} + {λ}_{X} ( t ) {ϕ}_{r} {ϕ}_{X}$$

Note that the terms in the Hamiltonian including the λ_{A}, λ_{B}, and λ_{X} terms describe the coupling between the relay oscillators and the other three oscillators, e.g., the output oscillator 1206, the bias oscillator 1212, and the input oscillator 1208. Also, note that all three coupling terms are time dependent, based on the λ_{A}, λ_{B}, and λ_{X} pulses controlled by controller 1214. Additionally, note that the mass (or the frequency) of the relay oscillator 1218 is time dependent, where the mass (or frequency) of the relay oscillator is also controlled by controller 1214.

More particularly, the controller 1214 emits pulses λ_{A} to couple the position degree of freedom (ϕ_{y}) of the output oscillator 1206 to the position degree of freedom (ϕᵣ) of the relay oscillator 1218. This coupling may remain turned on for some time. Then, once the coupling between the position degree of freedom (ϕ_{y}) of the output oscillator 1206 and the position degree of freedom (ϕᵣ) of the relay oscillator 1218 is turned off, the controller 1214 causes pulses λ_{B} to be emitted to couple the position degree of freedom (ϕᵣ) of the relay oscillator 1218 to the position degree of freedom (ϕ_{b}) of the bias oscillator 1212, and simultaneously emits control signals to cause the mass of the relay oscillator 1218 to be increased (or alternatively emits control signals to cause the oscillation frequency of the relay oscillator 1218 to be tuned, for example decreased). When coupled to the relay oscillator 1218, the bias position degree of freedom (ϕ_{b}) of the bias oscillator 1212 acts as a bias to the relay oscillator 1218 and helps to ensure that the relay position degree of freedom (ϕᵣ) of the relay oscillator 1218 maintains its equilibrium value (that it has acquired from the output oscillator 1206). After the relay oscillator 1218 has reached an appropriately large mass (or tuned frequency), the controller 1214 causes pulses λ_{X} to be emitted to couple the position degree of freedom (πᵣ) of the relay oscillator 1218 (having the increased mass or tuned frequency) to the position degree of freedom (π_{X}) of the input oscillator 1208. Also, in some embodiments, the controller 1214 may cause pulses λ_{X} and pulses λ_{B} to be emitted at the same time, such that the relay oscillator 1218 is coupled to the bias oscillator 1212 simultaneously with being coupled to the input oscillator 1208. Note that in the illustration shown in FIG. 12A either of EBMs 1200 or 1202 may be a block of a hierarchical architecture 100, that is to say the input to the block may come from another block or the destination of the information being relayed may be another block. FIG. 12A is illustrating a more general case for the relay gadget where the inputs and outputs are general EBMs, but it should be understood that the analog Swish gadget is a particular implementation of an EBM having an engineered potential that implements the Swish function.

In some embodiments the following pulse shapes may be used for λ_{A}, λ_{B}, and λ_{X}. Though in some embodiments, other suitable pulse shapes may be used.

$$\begin{matrix}{λ}_{A} ( t ) = {λ}_{A} ( σ ( {k}_{A} ( t - {t}_{1} ) ) - σ ( {k}_{A} ( t - {t}_{2} ) ) ) \\ {λ}_{B} ( t ) = - {λ}_{B} σ ( {k}_{B} ( t - {t}_{1}^{( B )} ) ) + {λ}_{0}^{( B )} \\ {λ}_{X} ( t ) = {λ}_{X} σ ( {k}_{X} ( t - {t}_{1}^{( X )} ) ) + {λ}_{0}^{( X )}\end{matrix}$$

where σ(t) is the sigmoid function:

$$σ ( t ) = \frac{1}{1 + {e}^{- t}} .$$

In some embodiments, λ_{A}, λ_{B}, and λ_{X}, as well as k_{A}, k_{B}, and k_{X} may be tuned to improve results. Also, times, t₁, t₂, t₁^{(B)}, and t₁^{(X)} may be tuned.

Without loss of generality, the position degree of freedom of the output oscillator 1206 (ϕ_{y}) is considered to have an equilibrium value (yₑ) (after energy-based model 1200 has evolved for some time and reached a thermal equilibrium). Also, the position degree of freedom (ϕ_{y}) of the output oscillator 1206 is considered to have a potential given by

$$\frac{1}{2} {m}_{y} {{ω}_{y}^{2} ( {ϕ}_{y} - {y}_{e} )}^{2} .$$

It should be noted in practice that the output oscillator 1206 may be coupled to various other oscillators of the first energy-based model 1200 (as shown in FIG. 12A) which would cause it to have the yₑ equilibrium value. Thus, to be more comprehensive,

$$\frac{1}{2} {m}_{y} {{ω}_{y}^{2} ( {ϕ}_{y} - {y}_{e} )}^{2} .$$

may be replaced by a potential term that takes into account these couplings, such as

$$\frac{1}{2} {m}_{y} {{ω}_{y}^{2} ( {ϕ}_{y} - {y}_{e} )}^{2} + {\sum }_{j} {λ}_{Y}^{( j )} {φ}_{y} {φ}_{j} or \frac{1}{2} {m}_{y} {{ω}_{y}^{2} ( {φ}_{y} - {y}_{e} )}^{2} + {λ}_{Y} {\sum }_{j} {{λ}_{Y}^{( j )} ( {φ}_{y} - {φ}_{j} )}^{2} ,$$

where the ϕⱼ degrees of freedom are degrees of freedom of other oscillators in the first energy-based model 1200 that are coupled to the position degree of freedom (ϕ_{y}) of the output oscillator 1206. However, this difference (or said another way, simplification) manifests itself in a slightly different value for the equilibrium value (yₑ), or depending on the couplings, may result in the same yₑ equilibrium value. But this simplification does not affect the equilibrium results of the relay oscillator 1218. A similar issue applies to the input oscillator 1208, which is also coupled to other oscillators of the second energy-based model 1202. Also, in some embodiments, multiple relay oscillators 1210 may be coupled to multiple input oscillators (e.g. additional input oscillators in addition to input oscillator 1208). Note that the relay oscillator 1218 and the relay gadget 1204 impart the equilibrium value of the output oscillator to the input oscillator, such that the position degree of freedom (ϕ_{X}) of the input oscillator 1208 inherits the same equilibrium value as the position degree of freedom (ϕ_{y}) of the output oscillator 1206, e.g. the position it had when first coupled to the relay oscillator 1218 of the relay gadget 1204. As such, thermodynamic information is relayed from the output oscillator 1206 to the input oscillator 1208 while remaining in a thermodynamic state. For example, analog information is passed between the first energy-based model 1200 and the second energy-based model 1202 without requiring a measurement by a classical computing device. Further note, this is done in an analog way (as opposed to a digitization that would take place during readout and re-initialization).

For a system undergoing Langevin dynamics, the equation of motion of a given oscillator (k) is given by:

$$\begin{matrix}\frac{d {φ}_{k} ( t )}{d t} = \frac{\partial {H}_{f a n}}{\partial {π}_{k}} \\ \frac{{π}_{k} ( t )}{d t} = - γ {π}_{k} ( t ) - \frac{\partial {H}_{f a n}}{\partial {φ}_{k}} {\vert}_{t} + \sqrt{2 {m}_{k} γ {k}_{B} T} \frac{d {W}_{t}}{d t}\end{matrix}$$

where φ denotes the position degree of freedom of the oscillator and π denotes the momentum degree of freedom of the oscillator. Using the Hamiltonian for the coupled system shown in FIG. 12A (which is given further above) and the equations of motion for position and momentum given directly above, the equations of motions for the relay oscillator 1218, output oscillator 1206, the bias oscillator 1212, and the input oscillator 1208, are respectively given by:
Equation of Motion for the Relay Oscillator:

$${m}_{r} ( t ) \frac{{d}^{2} {ϕ}_{r}}{d {t}^{2}} + \frac{d {m}_{r} ( t )}{dt} \frac{d {ϕ}_{r}}{dt} + γ {m}_{r} ( t ) \frac{d {ϕ}_{r}}{d t} = - ( - 2 {λ}_{A} ( t ) ( {ϕ}_{y} - {ϕ}_{r} ) + {λ}_{B} ( t ) {ϕ}_{b} + {λ}_{X} ( t ) {ϕ}_{x} + {m}_{r} ( t ) {ω}_{r}^{2} {ϕ}_{r} ) + \sqrt{2 {m}_{r} ( t ) {k}_{B} T} \frac{d {W}_{t}^{( r )}}{d t}$$

$$Or$$

$${m}_{r} ( t ) \frac{{d}^{2} {φ}_{r}}{d {t}^{2}} + \frac{d {m}_{r} ( t )}{dt} \frac{d {φ}_{r}}{dt} + γ {m}_{r} ( t ) \frac{d {φ}_{r}}{d t} = - ( - 2 {λ}_{A} ( t ) ( {φ}_{y} - {φ}_{r} ) - 2 {λ}_{B} ( t ) ( {φ}_{b} - {φ}_{r} ) + 2 {λ}_{X} ( t ) ( {φ}_{r} - {φ}_{x} ) + {m}_{r} ( t ) {ω}_{r}^{2} {φ}_{r} ) + \sqrt{2 {m}_{r} ( t ) {k}_{B} T} \frac{d {W}_{t}^{( r )}}{d t}$$

Depending on whether there is a linear or quadratic coupling.
Equation of Motion for the Output Oscillator:

$${m}_{y} \frac{{d}^{2} {φ}_{y}}{d {t}^{2}} + γ {m}_{y} \frac{d {φ}_{y}}{d t} = - ( {λ}_{A} ( t ) {φ}_{y} + {m}_{y} {ω}_{y}^{2} ( {φ}_{y} - {φ}_{c} ) ) + \sqrt{2 {m}_{y} {k}_{B} T} \frac{d {W}_{t}^{( y )}}{d t}$$

$$Or$$

$${m}_{y} \frac{{d}^{2} {φ}_{y}}{d {t}^{2}} + γ {m}_{y} \frac{d {φ}_{y}}{d t} = - ( 2 {λ}_{A} ( t ) ( {φ}_{y} - {φ}_{r} ) + {m}_{y} {ω}_{y}^{2} ( {φ}_{y} - {φ}_{c} ) ) + \sqrt{2 {m}_{y} {k}_{B} T} \frac{d {W}_{t}^{( y )}}{d t}$$

Depending on whether there is a linear or quadratic coupling.

$${m}_{b} \frac{{d}^{2} {φ}_{b}}{d {t}^{2}} + γ {m}_{b} \frac{d {φ}_{b}}{d t} = - ( {λ}_{B} ( t ) {φ}_{r} + {m}_{b} {ω}_{b}^{2} {φ}_{b} ) + \sqrt{2 {m}_{b} {k}_{B} T} \frac{d {W}_{t}^{( b )}}{d t}$$

$$Or$$

$${m}_{b} \frac{{d}^{2} {φ}_{b}}{d {t}^{2}} + γ {m}_{b} \frac{d {φ}_{b}}{d t} = - ( - 2 {λ}_{B} ( t ) ( {φ}_{r} - {φ}_{b} ) + {m}_{b} {ω}_{b}^{2} {φ}_{b} ) + \sqrt{2 {m}_{b} {k}_{B} T} \frac{d {W}_{t}^{( b )}}{d t}$$

Equation of Motion for the Bias Oscillator:
   Depending on Whether there is a Linear or Quadratic Coupling.

Equation of motion for the input oscillator:

$${m}_{x} \frac{{d}^{2} {φ}_{x}}{d {t}^{2}} + γ {m}_{x} \frac{d {φ}_{x}}{d t} = - ( {λ}_{X} ( t ) {φ}_{r} + {m}_{x} {ω}_{x}^{2} {φ}_{x} ) + \sqrt{2 {m}_{x} {k}_{B} T} \frac{d {W}_{t}^{( x )}}{d t}$$

$$Or$$

$${m}_{x} \frac{{d}^{2} {φ}_{x}}{d {t}^{2}} + γ {m}_{x} \frac{d {φ}_{x}}{d t} = - ( - 2 {λ}_{X} ( t ) ( {φ}_{r} - {φ}_{x} ) + {m}_{x} {ω}_{x}^{2} {φ}_{x} ) + \sqrt{2 {m}_{x} {k}_{B} T} \frac{d {W}_{t}^{( x )}}{d t}$$

Depending on whether there is a linear or quadratic coupling.

Also, the time dependent mass of the relay oscillator 1218 is given by:

$${m}_{r} ( t ) = {m}_{f}^{( r )} σ ( {k}_{r} ( t - {t}_{r} ) ) + {m}_{r} .$$

FIG. 12B is a high-level diagram similar to FIG. 12A, wherein the relay gadget does not include a bias oscillator, according to some embodiments.

In some embodiments, such as when the relay oscillator is configured to have a controllable time-dependent mass, the use of a bias oscillator may be omitted. For example, if the product of mass times frequency squared of a first oscillator is much larger than the product of mass times frequency of a second oscillator (that is coupled to the first oscillator) the position degree of freedom of the first oscillator (having the larger value for the product of mass times frequency squared) may be treated as a constant. Thus, for embodiments, wherein the mass of the relay oscillator can be increased such that the product of mass times frequency squared of the relay oscillator is sufficiently large, it may not be necessary to further use a bias oscillator.

More particularly, consider two oscillators (oscillator a and oscillator b) with position degrees of freedom ϕₐ and ϕₚ. Suppose that ϕ_{b} has equilibrium value b_{c}. Assume ϕ_{b} is a constant and consider the Hamiltonian:

$${H}_{1} = \frac{1}{2} {m}_{a} {ω}_{a}^{2} {ϕ}_{a}^{2} + {λϕ}_{a} {b}_{c}$$

In this case, the expectation value of Pa at thermal equilibrium is given by:

$$〈 {φ}_{a} 〉 = \frac{\int a {e}^{- β {H}_{1}} d a}{\int {e}^{- β {H}_{1}} d a} = \frac{λ {b}_{c}}{{m}_{a} {ω}_{a}^{2}}$$

Choosing λ=−mₐωₐ², it gives [symbol] ϕₐ [symbol] =_{b}c.

Also, considering the dynamics of ϕZ_{b}. The Hamiltonian is:

$${H}_{2} = \frac{1}{2} {m}_{a} {ω}_{a}^{2} {ϕ}_{a}^{2} + \frac{1}{2} {m}_{b} {{ω}_{b}^{2} ( {ϕ}_{b} - {b}_{c} )}^{2} + {λϕ}_{a} {ϕ}_{b}$$

Moreover, using H₂, [symbol] ϕₐ [symbol] is given by:

$$〈 {φ}_{a} 〉 = \frac{\int a {e}^{- β {H}_{2}} dadb}{\int {e}^{- β {H}_{2}} dadb} = \frac{λ {b}_{c}}{{m}_{a} {ω}_{a}^{2} - \frac{{λ}^{2}}{{m}_{b} {ω}_{b}^{2}}} = \frac{{b}_{c}}{1 - \frac{{m}_{a} {ω}_{a}^{2}}{{m}_{b} {ω}_{b}^{2}}}$$

where λ is set such that λ=−mₐωₐ². Note that if mₐωₐ²<<m_{b}ω_{b}², then [symbol] ϕₐ [symbol] ˜b_{c}. As such as long as the mass times frequency squared of the oscillator a having position degree of freedom ϕₐ is much less than the mass times frequency squared of the oscillator b having position degree of freedom ϕ_{b}, the position degree of freedom ϕ_{b} can be treated as a constant, with the constant being the thermal equilibrium value of ϕ_{b}.

Said another way, if the product of mass times frequency squared of the relay oscillator 1218 is increased to be sufficiently large, then the inherited equilibrium value acquired from the output oscillator 1206 can be treated as a constant, while held by the relay oscillator 1218. Also, as long as the product of mass times frequency squared of the relay oscillator 1218 is sufficiently large as compared to the corresponding value of mass times frequency squared of the input oscillator 1208, the position degree of freedom of the relay oscillator may be treated as a constant, such that it relays the held equilibrium value acquired from the output oscillator 1206 of the first EBM 1200 to the input oscillator 1208 of the second EBM 1202.

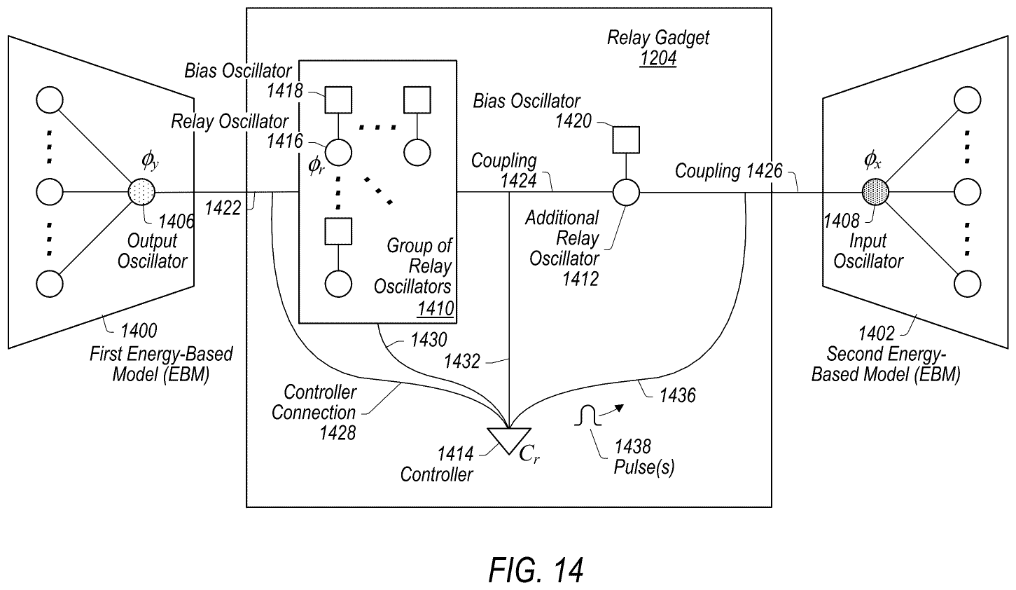

Note that the relay oscillators used in the relay gadget configurations shown in FIGS. 14-17 include bias oscillators. However, in some embodiments, similar configurations may be used that do not include bias oscillators. For example, relay oscillators as shown in FIG. 12A or as shown in FIG. 12B may be used to construct the relay gadgets shown in FIGS. 14-17.

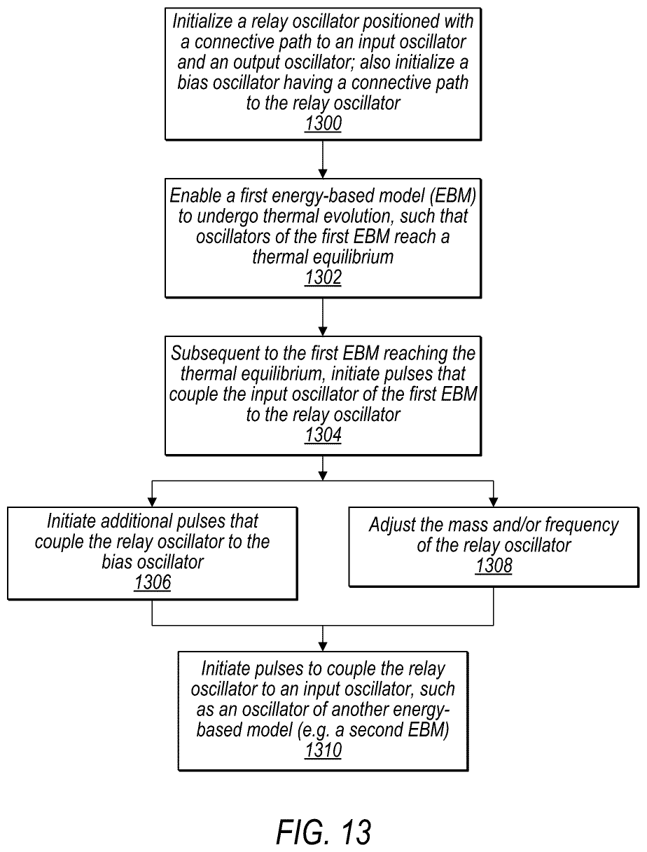

FIG. 13 is a high-level flowchart illustrating a process of relaying thermodynamic information between an output oscillator, such as of a first energy-based model (EBM), and an input oscillator, such as of an analog Swish gadget, according to some embodiments.

At block 1300 a relay oscillator is initialized, wherein the relay oscillator is positioned such that it has connectivity to an output oscillator, such as output oscillator 1206 of energy-based model 1200, and has connectivity to an input oscillator, such as input oscillator 1208 of energy-based model 1202. Additionally, a bias oscillator is initialized, wherein the bias oscillator has connectivity to the relay oscillator. For example, bias oscillator 1212 may be initialized and is positioned in a way that it can be coupled to relay oscillator 1218.

At block 1302, the first energy-based model comprising the output oscillator, such as energy-based model 1200 that includes output oscillator 1206, is enabled to undergo thermal evolution such that the energy-based model evolves according to Langevin dynamics. The evolution may be enabled to occur for an amount of time such that the first energy-based model reaches a thermal equilibrium. As an example, the first energy-based model may represent a trained model that is configured to perform inference, and at least some oscillators of the first energy-based model may be clamped to input data, wherein inference results are represented by other oscillators of the first energy-based model subsequent to the thermal evolution. For example, output oscillator 1206 may represent the results of a computation performed by the energy-based model 1200 that are to be relayed as input data to the second energy-based model 1202.

At block 1304, once the oscillators of the first energy-based model (e.g. energy-based model 1200) have reached thermal equilibrium, the controller 1214 initiates pulses (e.g. λ_{A}(t) pulses) to cause the output oscillator 1206 to be coupled to the relay oscillator (e.g. relay oscillator 1218).

At block 1306, the controller 1214 initiates additional pulses (e.g., λ_{B}(t) pulses) that cause the relay oscillator to be coupled to the bias oscillator. Recall that initially the relay oscillator 1218 may have a small mass and/or frequency combination, e.g., small relative to the product of mass times frequency squared of the output oscillator 1206. Because the relay oscillator has a small product of mass times frequency squared, the relay oscillator more readily takes on the position of the output oscillator (for example, as opposed to the relay oscillator pulling the output oscillator to take on the relay oscillator's position). However, due to the relatively small mass times frequency squared of the relay oscillator, if left alone the relay oscillator would quickly lose the recently inherited position, inherited from the output oscillator. To avoid this, the relay oscillator is coupled to the bias oscillator 1212 at or near the same time as the relay oscillator is un-coupled from the output oscillator 1206. The relay oscillator may also be coupled to the bias oscillator at or near the same time it is coupled to the input oscillator 1208. Coupling the relay oscillator to the bias oscillator helps the relay oscillator to maintain the acquired thermal information (e.g., position degree of freedom, or, in some embodiments, momentum degree of freedom) the relay oscillator has acquired from the output oscillator. Also, while coupled to the bias oscillator and prior to being coupled to the input oscillator of the next EBM, a mass and/or frequency of the relay oscillator is adjusted.

For example, at block 1308, the controller 1214 causes control signals to be emitted that cause the mass (or frequency) of the relay oscillator to be adjusted. The mass of the relay oscillator may be proportional to capacitance of a circuit used to implement the relay oscillator; a Cooper-pair box arrangement may be used to implement a time dependent capacitance in the circuit (e.g. where the capacitance corresponds to mass). In such embodiments, the controller 1214 is configured to emit control signals to cause the Cooper-pair box to increase the capacitance of the relay oscillator circuit. However, in other embodiments, mass may be kept constant, but instead frequency of the relay oscillator may be adjustable as a result of a time-dependent flux element of a circuit used to implement the relay oscillator. For example, a current inducing flux element may be added to the relay oscillator circuit. In such embodiments, controller 1214 may emit control signals that cause the flux of the relay oscillator to be tuned (where flux corresponds to frequency). In some embodiments blocks 1306 and 1308 are performed concurrently.

At block 1310, the controller 1214 initiates another set of one or more pulses (e.g., λ_{X}(t) pulses) to couple the relay oscillator to the input oscillator, such as input oscillator 1208. The bias oscillator 1212 may remain coupled to the relay oscillator 1218 when the relay oscillator 1218 is coupled to the input oscillator 1208. Note that since the relay oscillator has had its mass (and/or frequency) adjusted prior to the coupling to the input oscillator, and since the relay oscillator remains coupled to the bias oscillator, the relay oscillator has a large value of the product of mass times frequency squared relative to the input oscillator and therefore causes the input oscillator to take on the position of the relay oscillator, which corresponds to the position of the output oscillator. In this way, the relay gadget 1204 relays analog oscillator degree of freedom information (e.g. thermodynamic information) from the output oscillator to the input oscillator, without having to convert the thermodynamic information into classical form.

In some embodiments, a relay gadget, such as relay gadget 1204, may perform steps similar to those described in FIG. 13 in order to relay position degree of freedom thermodynamic information, momentum degree of freedom thermodynamic information, and/or force/acceleration degree of freedom thermodynamic information.

In some embodiments, a relay gadget, such as relay gadget 1204 may be used to store thermodynamic information, for example in the relay oscillator 1218. Also, in some embodiments, multiple relay gadgets may be used to form a thermodynamic network between thermodynamic components. Also, in some embodiments, a relay gadget may be used to perform conditional sampling, such as Gibbs sampling.

FIG. 14A is a high-level diagram illustrating an output oscillator, an input oscillator, and a relay gadget, wherein the relay gadget comprises a group of relay oscillators and is configured to relay expectation values of thermodynamic information between the output oscillator and the input oscillator, according to some embodiments.

In some embodiments, it is desired to transfer an expectation value of one energy-based model (EBM) to another EBM, such as from an output of a transformer neural network layer gadget to an input of another EBM. In some embodiments an instantaneous sample value may be transferred from an output oscillator of one EBM (such as from the output oscillator 1514 of analog Swish gadget 1508) to an input oscillator of another EBM. The instantaneous sample value of an output oscillator of a given EBM will follow a probability distribution associated with the potential well of the output oscillator and couplings of the output oscillator with the one or more oscillators belonging to the first EBM. An instantaneous sample value of the state of the output oscillator may be any possible value within the bounds of the potential well and respective couplings. In some instances, the instantaneous sample value of the output oscillator may be far off from the expectation value (e.g. due to thermodynamic fluctuations, anharmonic potentials, multiple well potentials, the coupling between the output oscillator with other oscillators belonging to a shared EBM, or a combination of factors). Furthermore, the output oscillator of an EBM may hop between wells of a potential, thus the expectation value may not be a probable outcome of an instantaneous sample of the output oscillator. To avoid these issues, in some embodiments expectation values may be stored instead of sample values and relayed as inputs to other EBMs.

In some embodiments, to enable an expectation value of an output of an EBM to be used as an input to a subsequent EBM in a fully analogue fashion (e.g. without the use of measurements), two or more relay oscillators may be used. In some embodiments, an expectation value is derivable from one or more sample values. In some embodiments, relay oscillators may be oscillators which may be arranged between the output of a given EBM and the input of an additional EBM in such a way that their state may be configured to take on a sample value of the output oscillators of a given EBM. In some embodiments, sample values may be collected in such a way (e.g. spatial or temporal arrangement of relay oscillators as described below) that a close approximation of an expectation value of an output of a given EBM may be represented on one or more relay oscillators. Classical controllers may be used to turn the couplings on and off between the output oscillators and relay oscillators, between respective relay oscillators, as well as to make the masses and frequencies of the relay oscillators time dependent. Nevertheless, measurements may not be required, and the timing of the operations may be computed during a compilation step.

In some embodiments, a relay gadget may include a group of one or more relay oscillators and an additional relay oscillator. One or more relay oscillators of the group of relay oscillators may be coupled to an output oscillator of a first EBM. The one or more relay oscillators may be coupled in such a way that respective sample values of the output oscillator of the first EBM, wherein the output oscillator has progressed through thermodynamic evolution, may be stored on respective ones of the relay oscillators of the first group of one or more relay oscillators. An additional relay oscillator may be coupled to one or more of the relay oscillators, wherein the coupling enables the additional relay oscillator to take on an expectation value of the output oscillator, wherein the expectation value is derivable based at least in part on the sample values. In some embodiments, bias oscillators may be used. In some embodiments, bias oscillators may not be used. For simplicity, embodiments are given with bias oscillators, but it should be understood that is some embodiments bias oscillators may not be used for each relay oscillator of a relay gadget, however, that does not limit the embodiments to only one way or the other.

In some embodiments, thermodynamic information is relayed from a first energy-based model (EBM) 1200 to a second energy-based model (EBM) 1202 via relay gadget 1204. The thermodynamic information of EBM 1200 is outputted via output oscillator 1206 and inputted into input oscillator 1208 via relay gadget 1204. The thermodynamic information may include, for example, samples of thermodynamic equilibrium of output oscillator 1206, or the expectation value of the output oscillator 1206. The expectation value is at least derivable based on samples values of the output oscillator 1206. Output oscillator 1206 may be governed by a potential wherein the potential follows a single-well potential, double-well potential, multi-well potential, or any generic potential that may be engineered. The output oscillator 1206 may also be coupled to other oscillators belonging to EBM 1200. For example, output oscillator 1206 may be output oscillator 1514 of analog Swish gadget 1508.

In some embodiments, an expectation value of one or more degrees of freedom of output oscillator 1206 may be influenced by a potential of output oscillator 1206 as well as couplings between output oscillator 1206 and one or more oscillators belonging to first energy-based model 1200. Potentials governing the dynamics of the output oscillator 1206 may have multiple wells. With generic arbitrary potentials (e.g. multiple wells) and coupling between output oscillator 1206 and one or more oscillators belonging to first energy-based model 1200, the position degrees of freedom of the output oscillators can hop between wells. As described herein, a relay gadget provides a solution to approximate an expectation value of the output oscillator. For example, using an approximated expectation value in forwards and backwards propagation may provide better results than using a sample value, as the expectation value better represents the state of the oscillator whose degree of freedom value is being relayed to a second oscillator.

Relay gadget 1204 comprises a group of relay oscillators 1402 and an additional relay oscillator 1408. The group of relay oscillators 1402 comprises one or more relay oscillators arranged with respective bias oscillators (e.g., relay oscillator 1404 arranged with bias oscillator 1406). As described later, relay oscillators in oscillator group 1402 may be configured and coupled in various ways (e.g. temporally and spatially) to transfer thermodynamic information. The additional relay oscillator 1408 may be connected to bias oscillator 1404. As discussed later, the additional relay oscillator 1408 may be configured and coupled in various ways to transfer thermodynamic information. For example, the group of relay oscillators 1402 transfers thermodynamic information to additional relay oscillator 1408 via coupling. Coupling may be controlled by on-chip classical controller 1214.

Output oscillator 1206 is coupled to the one or more relay oscillators of the group of relay oscillators 1402 via on-chip classical controller 1214. On-chip classical controller 1214 may send a pulse or a group of pulses to cause couplings between oscillators (e.g., coupling between output oscillator 1206 and relay oscillator 1404) or relay oscillators like 1404 and a bias oscillator like 1406 via pulses. Coupling is represented by lines and oscillators may be coupled or not coupled. When coupling is on, parameters of respective coupled oscillators affect the other oscillator it is coupled to. Couplings between oscillators within the group of relay oscillators 1402 are not expressly shown in FIG. 14 to emphasize that the coupling may take different configurations (e.g. temporal or spatial configurations as detailed below). Nevertheless, on-chip classical controller 1214 may cause a first set of one or more pulses to be emitted through controller connection, wherein the first set of pulses couples one or more relay oscillators of the group of relay oscillators 1402 to the output oscillator 1206 (e.g., turn on coupling). The on-chip classical controller 1214 is further configured to cause a second set of one or more pulses to be emitted through a path, wherein the second set of pulses couples one or more relay oscillators of the group of relay oscillators 1402 to the additional relay oscillator 1408 (e.g., turn on coupling). The on-chip classical controller 1214 is further configured to cause a third set of one or more pulses to be emitted, wherein the third set of pulses couples the additional relay oscillator 1408 to the input oscillator 1208 (e.g., turn on coupling).

In some embodiments, an additional relay oscillator 1408 takes on an expectation value of an output oscillator 1206 based at least in part on a coupling or couplings between a group of relay oscillators 1402, wherein respective relay oscillators of group 1402 comprise respective sample values of the output oscillator 1206. The additional relay oscillator 1408 may take on the expectation value of output oscillator 1206 based at least on respective sample values taken on by respective relay oscillators. Furthermore, additional relay oscillator 1408 may transfer the taken on expectation value to input oscillator 1208 via controller 1214 causing coupling to turn on.

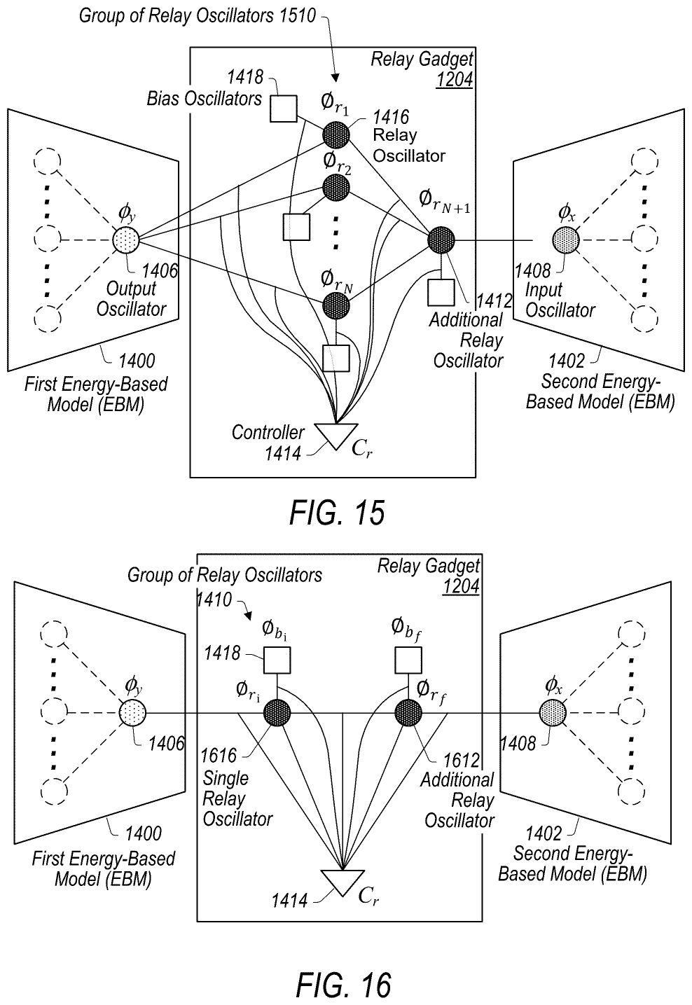

FIG. 15 is a high-level diagram illustrating a spatial analogue relay gadget, wherein respective ones of relay oscillators of a group of relay oscillators are configured to store respective sample values of an output oscillator, according to some embodiments.

In some embodiments, controller 1414 sends a first set of one or more pulses wherein the first set of pulses causes output oscillator 1406 of first energy-based model (EBM) 1400 to be coupled to at least one or more relay oscillators {ϕᵣ_{₁}, ϕᵣ_{₂}, . . . ϕᵣ_{_{N}}}, in the group of relay oscillators 1402. The group of relay oscillators 1402 comprises a plurality of relay oscillators, wherein respective relay oscillators {ϕᵣ_{₁}, ϕᵣ_{₂}, . . . ϕᵣ_{_{N}}}, are configured to store a sample of the output oscillator 1406 based at least in part on respective couplings between the respective ones of the relay oscillators (e.g., 1404) of the group of relay oscillators 1402 and the output oscillator 1406. The on-chip classical controller 1414 is further configured to cause another set of one or more pulses to be emitted, wherein the other set of pulses turns off the respective couplings between the output oscillator 1406 and the respective ones of the relay oscillator of the group of relay oscillators 1402 at different times. This may allow different samples of the output oscillator 1406 to be stored on the respective ones of the relay oscillators {ϕᵣ_{₁}, ϕᵣ_{₂}, . . . ϕᵣ_{_{N}}}.

On-chip classical controller 1414 may be further configured to cause a second set of one or more pulses to be emitted, wherein the second set of pulses turns on the coupling between respective ones of the relay oscillators with sample values of the output oscillator 1406 to an additional relay oscillator 1408. The coupling is configured to transfer an approximation of the expectation value of output oscillator 1406 based at least in part on the sample values stored on respective relay oscillators in the first group of relay oscillators 1402. Once the additional relay oscillator 1408 is tuned to the expectation value of output oscillator 1406, controller 1414 may cause a set of one or more pulses that may cause the additional relay oscillator 1408 to be coupled to input oscillator 1408. For ease of illustration a version that includes bias oscillators is shown. However, it should be understood that in some embodiments bias oscillators may be omitted.

FIG. 16 is a high-level diagram illustrating a temporal analogue relay gadget, wherein a group of relay oscillators comprises a single relay oscillator, according to some embodiments.

In some embodiments, the group of relay oscillators 1402 comprises a single relay oscillator 1404. The single relay oscillator 1404 is configured to store a sample of the output oscillator 1406 based at least in part on the coupling between the single relay oscillator 1404 and the output oscillator 1406. The coupling between output oscillator 1406 and single relay oscillator 1404 is caused by a first set of one or more pulses emitted from on-chip classical controller 1414. The on-chip classical controller 1414 is configured to cause a second set of one or more pulses to be emitted, wherein the second set of pulses causes the single relay oscillator 1404 to be coupled to additional relay oscillator 1412. The sequence of emitting the first set of pulses and then emitting the second set of pulses may be repeated numerous times. Each instance the sequence of the sequential sets of pulses is emitted, the position of additional relay oscillator 1412 is incrementally adjusted. Each adjustment may converge the additional relay oscillator 1412 to the expectation value of output oscillator 1406. For ease of illustration a version that includes bias oscillators is shown. However, it should be understood that in some embodiments bias oscillators may be omitted.

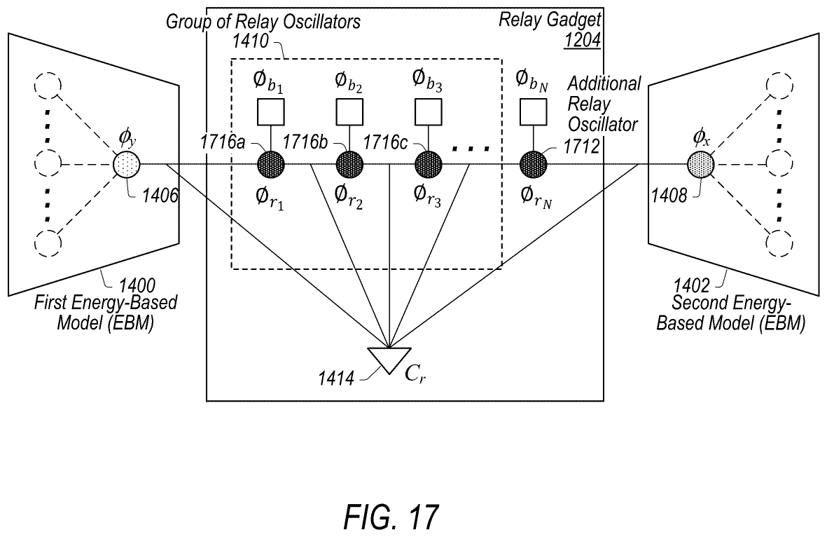

FIG. 17 is a high-level diagram illustrating a series analogue relay gadget, wherein a group of relay oscillators comprises a plurality of relay oscillators arranged in series, according to some embodiments.

For example, FIG. 17 shows a drawing of a series analogue relay gadget 1204. The group of relay oscillators 1402 comprises a plurality of relay oscillators {ϕᵣ_{₁}, ϕᵣ_{₂}, . . . } (e.g. relay oscillator 1716a, 1716b, 1716c) arranged one after another in series. Each relay oscillator has a product of mass and frequency squared. The first relay oscillator 1716a, ϕᵣ_{₁}, has the smallest product of mass and frequency squared. The next relay oscillator 1716b, ϕᵣ_{₂}, has a product of mass and frequency squared larger than the previous relay oscillator 1716a, ϕᵣ_{₁}. This trend of increasing the product of mass and frequency squared continues for each subsequent relay oscillator in the group of relay oscillators 1410. As last in the chain of relay oscillators, the additional relay oscillator 1712 has the largest product of mass and frequency squared. The couplings between relay oscillators and the coupling between the output oscillator 1406 and the first relay oscillator 1716a, ϕᵣ_{₁}, may be turned on at the same time and allowed to evolve thermodynamically according to Langevin dynamics. Once coupling is initiated, each successive relay oscillator takes continuous samples of the previous oscillator it is coupled to. Furthermore, each successive relay oscillator may be a closer approximation of the expectation value of the output oscillator 1406. In this manner, additional relay oscillator 1712 approximates an expectation value of input oscillator 1406. At this point, coupling between the additional relay oscillator 1712 and input oscillator 1408 may be turned on and the thermodynamic information may be transferred to input oscillator 1408. The number of relay oscillators and the timing of coupling may be chosen beforehand and optimized for a desired precision or accuracy of the expectation value of the output relay oscillator. For ease of illustration a version that includes bias oscillators is shown. However, it should be understood that in some embodiments bias oscillators may be omitted.

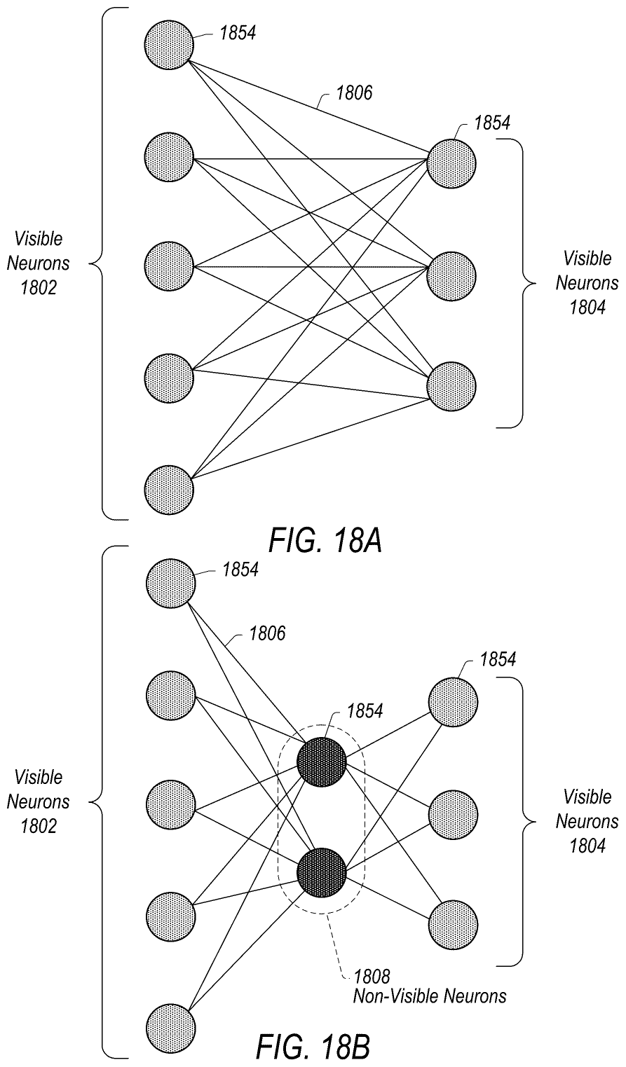

FIG. 18A illustrates example couplings between visible neurons of an energy-based model (EBM), according to some embodiments.

In some embodiments, input neurons and output neurons of an energy-based model, such as visible neurons 1802 and visible neurons 1804, may be directly linked via connected edges 1806. As shown in FIG. 18A, a given visible neuron 1802 of the five shown in the figure is connected, via edges 1806, to each of the respective three visible neurons 1804. A person having ordinary skill in the art should understand that FIG. 18A is meant to represent example embodiments of a graph architecture implemented using a thermodynamic processor that may be applied and that specific numbers of visible neurons 1802 and/or visible neurons 1804 shown in the figure are not meant to be restrictive. Additional configurations combining more/less visible neurons 1802 and/or visible neurons 1804 are also encompassed by the discussion herein. In addition, recall that neurons are logical representations of physical oscillators, such that, when describing neurons in FIGS. 18A and 18B, it should be understood that neurons and edges are implemented using oscillators and couplings.

FIG. 18B illustrates example couplings between visible neurons and non-visible neurons (e.g., hidden neurons) of an energy-based model (EBM), according to some embodiments.

In some embodiments, FIG. 18B may resemble additional example embodiments of an energy-based model architecture implemented using a thermodynamic processor. As shown in the figure, additional non-visible neurons 1808 may be used, which are respectively coupled, via edges 1806, to both visible neurons 1802 and to visible neurons 1804. Note that while the non-visible neurons are “not visible” from the perspective of inputs and outputs, the non-visible neurons may each correspond to a given oscillator. In addition, it may be noted that, in some embodiments that make use of non-visible neurons, no direct connections, via edges 1806, may be implemented between visible neurons 1802 and visible neurons 1804, but rather connections are routed firstly via non-visible neurons 1808, as shown in FIG. 18B. Couplings between visible and non-visible neurons may be additionally referred to herein as “layers” of a given energy-based model architecture that is implemented using a thermodynamic processor, according to some embodiments.

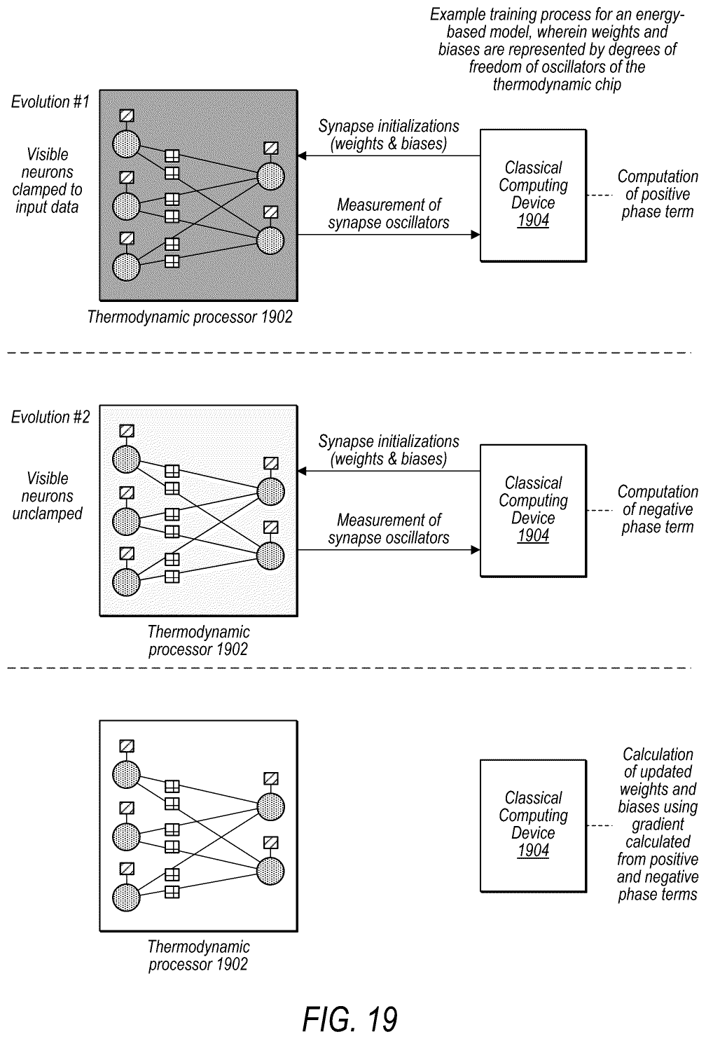

FIG. 19 is a high-level diagram illustrating a process of determining weights and biases to be used in an energy-based model (EBM), wherein the weights and biases are determined using measurement values for synapse oscillators, according to some embodiments.

As shown in FIG. 19, in a first evolution, visible neurons of an energy-based model implemented on a thermodynamic processor 1902 may be clamped to input data. For example, multiple mini-batches of input data may be clamped to visible neurons for multiple evolutions used to generate a first set of measurements used to compute a positive phase term. For example, the measurements may be used by classical computing device 1904 to compute the positive phase term.

Also, in a second (or other subsequent) evolution, the visible neurons may remain unclamped, such that the visible neuron oscillators are free to evolve along with the synapse oscillators during the second (or other subsequent) evolution. Measurements may also be taken and used by the classical computing device 1904 to compute a negative phase term.

Additionally, the positive and negative phase terms computed based on the first and second sets of measurements (e.g., clamped measurements and un-clamped measurements) may be used to calculate updated weights and biases.

This process may be repeated, with the determined updated weights and biases used as initial weights and biases for a subsequent iteration. In some embodiments, inferences generated using the updated weights and biases may be compared to training data to determine if the energy-based model has been sufficiently trained. If so, the model may transition into a mode of performing inferences using the learned weights and biases. If not sufficiently trained, the process may continue with additional iterations of determining updated weights and biases.

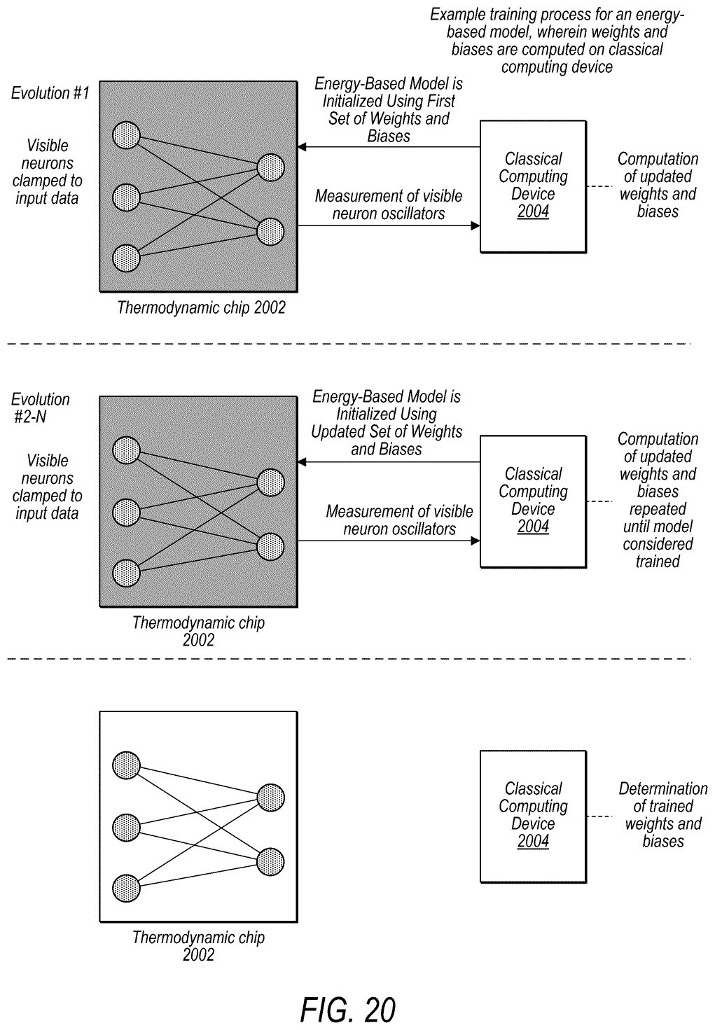

FIG. 20 is a high-level diagram illustrating a process of determining weights and biases to be used in an energy-based model (EBM), wherein the weights and biases are computed using a classical computing device, according to some embodiments.

In some embodiments, updated weights and bias values may be computed iteratively by classical computing device 2004 based on inference measurements from thermodynamic processor 2002. For example, inference values may be compared to training data values, and new weights and biases may be iteratively computed until the inference values closely correspond to the training data. As can be seen in FIG. 20, in some embodiments the synapse oscillator may be omitted as degrees of freedom of the energy-based model. For example, when a classical computing device is used to iteratively determine the weight and bias values.

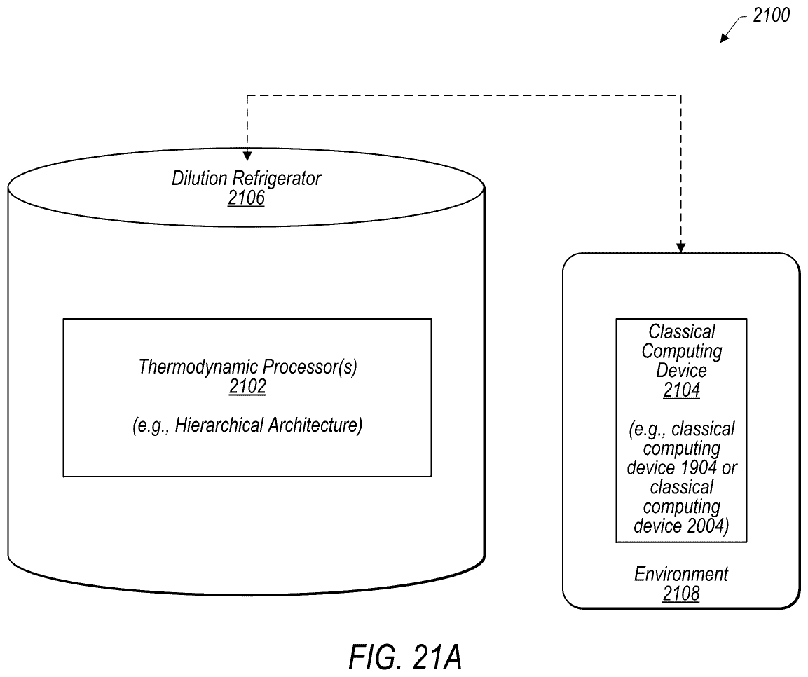

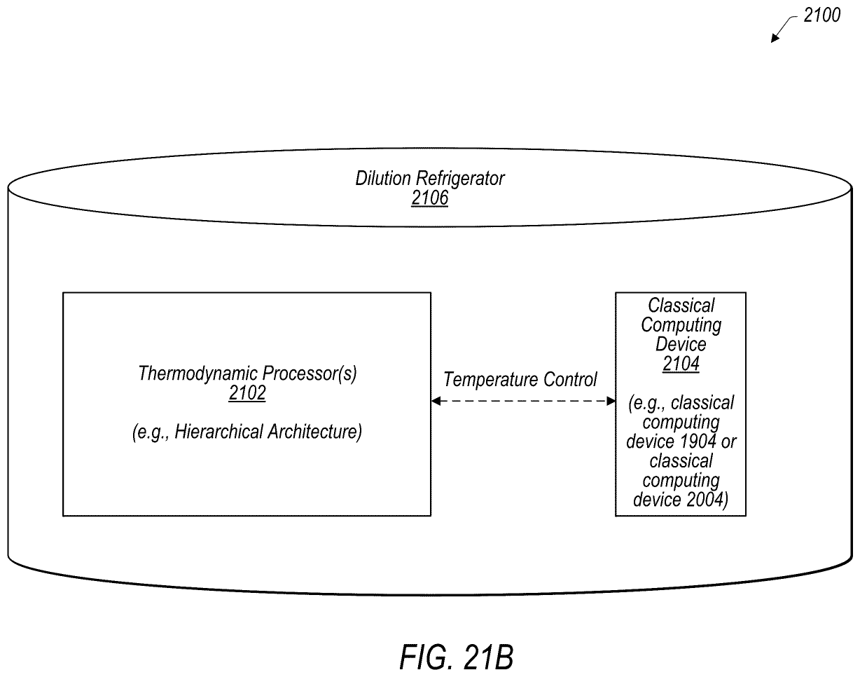

FIG. 21A is high-level diagram illustrating an example neuro-thermodynamic computer comprising a thermodynamic processor (e.g., that implements multiple energy-based models (EBMs) and a relay gadget) included in a dilution refrigerator and coupled to a classical computing device in an environment external to the dilution refrigerator, according to some embodiments.

In some embodiments, a neuro-thermodynamic computing system 2100 (as shown in FIG. 21) may be used to implement the various embodiments shown in FIGS. 1-20 and may include one or more thermodynamic processor(s) 2102 placed in a dilution refrigerator 2106. In some embodiments, classical computing device 2104 may control temperature for dilution refrigerator 2106, and/or perform other tasks, such as helping to drive a pulse drive to change respective hyperparameters of the given system and/or perform measurements, such as those shown in FIGS. 1-20. Also, the classical computing device 2104 may perform other simple computing operations, such as are needed to determine updated weights and biases.

In some embodiments, classical computing device 2104 may include one or more devices such as a field-programmable gate array (FPGA), an application specific integrated circuit (ASIC), and/or other devices that may be configured to interact and/or interface with a thermodynamic processor within the architecture of neuro-thermodynamic computer 2100. For example, such devices may be used to tune hyperparameters of the given thermodynamic system, etc. as well as perform part of the calculations necessary to determine updated weights and biases. In some embodiments, the classical computing device 2104 may be placed in an environment 2106 outside of the dilution refrigerator 2106.

As shown in FIG. 21A, in embodiments where more than one thermodynamic processor is used with a relay gadget, multiple ones of the thermodynamic processors and the relay gadget may be placed in the same dilution refrigerator 2106.

FIG. 21 is high-level diagram illustrating an example neuro-thermodynamic computer comprising a thermodynamic processor (e.g., that implements multiple energy-based models (EBMs) and a relay gadget) included in a dilution refrigerator and coupled to a classical computing device that is also included in the dilution refrigerator, according to some embodiments.

As another alternative, in some embodiments, a classical computing device used in a neuro-thermodynamic computer, such as in neuro-thermodynamic computer 2100, may be included in a dilution refrigerator with the thermodynamic processor. For example, neuro-thermodynamic computer 2100 includes both thermodynamic processor 2102 and classical computing device 2104 in dilution refrigerator 2106.

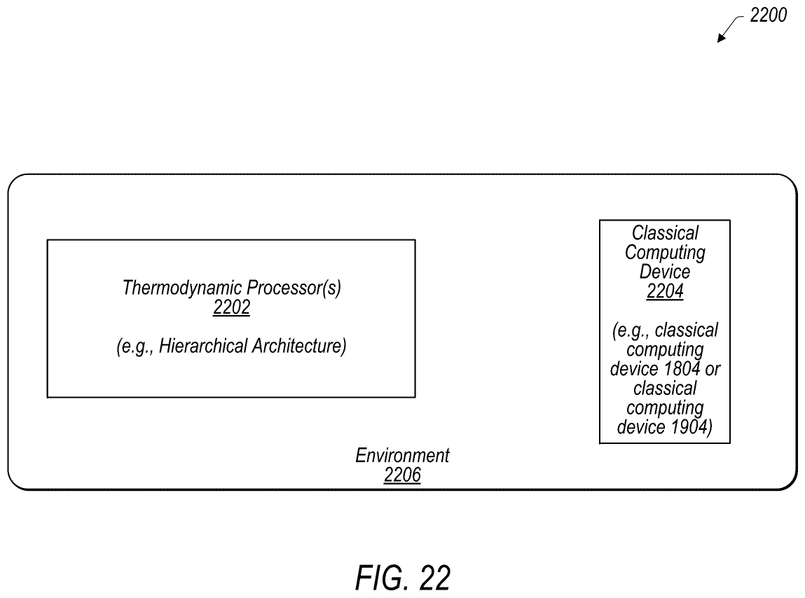

FIG. 22 is high-level diagram illustrating an example neuro-thermodynamic computer comprising one or more thermodynamic processors (e.g., that implement respective energy-based models (EBMs) and a relay gadget) coupled to a classical computing device in an environment other than a dilution refrigerator, according to some embodiments.

Also, in some embodiments, a neuro-thermodynamic computer, such as neuro-thermodynamic computer 2200, may be implemented in an environment other than a dilution refrigerator. For example, neuro-thermodynamic computer 2200 includes thermodynamic processor(s) 2202 and classical computing device 2204, in environment 2206. In some embodiments, environment 2206 may be temperature controlled and, the classical computing device (or other device) may control the temperature of environment 2206 in order to achieve a given level of evolution according to Langevin dynamics.

FIG. 23 is a high-level diagram illustrating oscillators included in a substrate of the thermodynamic processor and mapping of the oscillators to logical neurons of the thermodynamic processor, according to some embodiments.

In some embodiments, a substrate 2302 may be included in a thermodynamic processor, such as any one of the thermodynamic processors described above. Oscillators 2304 of substrate 2302 may be mapped in a logical representation 2352 to neurons 2354, as well as weights and biases (shown in FIG. 24). In some embodiments, oscillators 2304 may include oscillators with potentials ranging from a single well potential to a dual-well potential and may be mapped to visible neurons, weights, and biases.

In some embodiments, Josephson junctions and/or superconducting quantum interference devices (SQUIDS) may be used to implement and/or excite/control the oscillators 2304. In some embodiments, the oscillators 2304 may be implemented using superconducting flux elements (e.g., qubits). In some embodiments, the superconducting flux elements may physically be instantiated using a superconducting circuit built out of coupled nodes comprising capacitive, inductive, and Josephson junction elements, connected in series or parallel, such as shown in FIG. 23 for oscillator 2304. However, in some embodiments, generally speaking various non-linear flux loops may be used to implement the oscillators 2304, such as those having single-well potential, double-well potential, or various other potentials, such as a potential somewhere between a single-well potential and a double-well potential.

FIG. 24 is an additional high-level diagram illustrating oscillators included in a substrate of the thermodynamic processor mapped to logical neurons, weights, and biases of a given neuro-thermodynamic computing system, according to some embodiments.

While weights and biases are not shown in FIG. 23 for ease of illustration, respective ones of the visible neurons 2354 of FIG. 23 may each have an associated bias, and edges connecting the neurons 2354 may have associated weights. Each of the weights and biases may be mapped to oscillators in the thermodynamic processor, as well as the visible (and non-visible) neurons being mapped to oscillators in the thermodynamic processor. For example, FIG. 24 shows a portion of a thermodynamic processor, wherein weights and biases associated with a given neuron 2454 are shown. For example, bias 2456 may be a bias value for visible neuron 2454 and weights 2458 and 2460 may be weights for edges formed between visible neuron 2454 and other visible neurons of the thermodynamic processor. As shown in FIG. 24, each of the chip elements (visible neuron 2454, bias 2456, weight 2458, and weight 2460) may be mapped to separate ones of oscillators 2404. This may allow the visible neurons (and/or hidden neurons), weights, and biases to have independent degrees of freedom within a given thermodynamic processor that can separately evolve.

In some embodiments, oscillators associated with weights and biases, such as bias 2456 and weights 2458 and 2460, may be allowed to evolve during a training phase and may be held nearly constant during an inference phase. For example, in some embodiments, larger “masses” may be used for the weights and biases such that the weights and biases evolve more slowly than the visible neurons. This may have the effect of holding the weight values and the bias values nearly constant during an evolution phase used for generating inference values.

### Illustrative Computer System

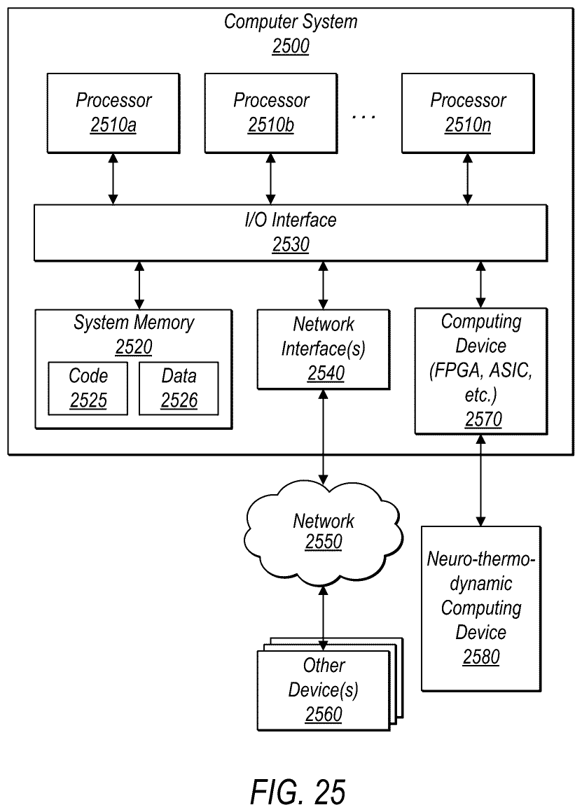

FIG. 25 is a block diagram illustrating an example computer system that may be used in at least some embodiments. In some embodiments, the computing system shown in FIG. 25 may be used, at least in part, to implement any of the techniques described above in FIGS. 1-24. Furthermore, computer system 2500 may be configured to interact and/or interface with self-learning neuro-thermodynamic computing device 2580, according to some embodiments.

In the illustrated embodiment, computer system 2500 includes one or more processors 2510 coupled to a system memory 2520 (which may comprise both non-volatile and volatile memory modules) via an input/output (I/O) interface 2530. Computer system 2500 further includes a network interface 2540 coupled to I/O interface 2530. Classical computing functions may be performed on a classical computer system, such as computing computer system 2500.

Additionally, computer system 2500 includes computing device 2570 coupled to thermodynamic processor 2580. In some embodiments, computing device 2570 may be a field programmable gate array (FPGA), application specific integrated circuit (ASIC) or other suitable processing unit. In some embodiments, computing device 2570 may be a similar computing device as described in FIGS. 1-24, such as classical computing devices 1904. In some embodiments, neuro thermodynamic computing device 2580 may be a similar neuro thermodynamic computing device as described in FIGS. 1-24, such as neuro thermodynamic computing devices implemented using thermodynamic processor(s) 100.

In various embodiments, computer system 2500 may be a uniprocessor system including one processor 2510, or a multiprocessor system including several processors 2510 (e.g., two, four, eight, or another suitable number). Processors 2510 may be any suitable processors capable of executing instructions. For example, in various embodiments, processors 2510 may be general-purpose or embedded processors implementing any of a variety of instruction set architectures (ISAs), such as the x86, PowerPC, SPARC, or MIPS ISAs, or any other suitable ISA. In multiprocessor systems, each of processors 2510 may commonly, but not necessarily, implement the same ISA. In some implementations, graphics processing units (GPUs) may be used instead of, or in addition to, conventional processors.

System memory 2520 may be configured to store instructions and data accessible by processor(s) 2510. In at least some embodiments, the system memory 2520 may comprise both volatile and non-volatile portions; in other embodiments, only volatile memory may be used. In various embodiments, the volatile portion of system memory 2520 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random-access memory (ReRAM), three-dimensional NAND technologies, Ferroelectric RAM, magneto resistive RAM (MRAM), or any of various types of phase change memory (PCM) may be used at least for the non-volatile portion of system memory. In the illustrated embodiment, program instructions and data implementing one or more desired functions, such as those methods, techniques, and data described above, are shown stored within system memory 2520 as code 2525 and data 2526.

In some embodiments, I/O interface 2530 may be configured to coordinate I/O traffic between processor 2510, system memory 2520, computing device 2570, and any peripheral devices in the computer system, including network interface 2540 or other peripheral interfaces such as various types of persistent and/or volatile storage devices. In some embodiments, I/O interface 2530 may perform any necessary protocol, timing or other data transformations to convert data signals from one component (e.g., system memory 2520) into a format suitable for use by another component (e.g., processor 2510). In some embodiments, I/O interface 2530 may include support for devices attached through various types of peripheral buses, such as a variant of the Peripheral Component Interconnect (PCI) bus standard or the Universal Serial Bus (USB) standard, for example. In some embodiments, the function of I/O interface 2530 may be split into two or more separate components, such as a north bridge and a south bridge, for example. Also, in some embodiments some or all of the functionality of I/O interface 2530, such as an interface to system memory 2520, may be incorporated directly into processor 2510.

Network interface 2540 may be configured to allow data to be exchanged between computing device 2500 and other devices 2560 attached to a network or networks 2550, such as other computer systems or devices. In various embodiments, network interface 2540 may support communication via any suitable wired or wireless general data networks, such as types of Ethernet network, for example. Additionally, network interface 2540 may support communication via telecommunications/telephony networks such as analog voice networks or digital fiber communications networks, via storage area networks such as Fibre Channel SANs, or via any other suitable type of network and/or protocol.

In some embodiments, system memory 2520 may represent one embodiment of a computer-accessible medium configured to store at least a subset of program instructions and data used for implementing the methods and apparatus discussed in the context of FIG. 1 through FIG. 24. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computer system 2500 via I/O interface 2530. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computer system 2500 as system memory 2520 or another type of memory. In some embodiments, a plurality of non-transitory computer-readable storage media may collectively store program instructions that when executed on or across one or more processors implement at least a subset of the methods and techniques described above. A computer-accessible medium may further include transmission media or signals such as electrical, electromagnetic, or digital signals, conveyed via a communication medium such as a network and/or a wireless link, such as may be implemented via network interface 2540. Portions or all of multiple computing devices such as that illustrated in FIG. 25 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computer system”, as used herein, refers to at least all these types of devices, and is not limited to these types of devices.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g., SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures above and described herein represent exemplary embodiments of methods. The methods may be implemented in software, hardware, or a combination thereof. The order of method may be changed, and various elements may be added, reordered, combined, omitted, modified, etc.

It will also be understood that, although the terms first, second, etc., may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. A system comprising:
oscillators of one or more thermodynamic processors configured to:
be coupled to each other, wherein the oscillators and the couplings implement one or more engineered energy potential for respective ones of one or more energy based models (EBMs), wherein the one or more EBMs corresponds to a probability distribution function; and
obtain thermodynamic data corresponding to parameters of the EBMs;
one or more relay oscillators of the one or more thermodynamic processors comprising adjustable masses or frequencies, wherein the oscillators and the one or more relay oscillators implements a block layer of a hierarchical thermodynamic computing architecture; and
one or more classical controllers configured to send pulses, wherein the pulses cause:
couplings between the oscillators and the one or more relay oscillators to be turned on or off;
oscillators to be initialized to thermodynamic data from a prior thermodynamic evolution;
a product of mass and frequency squared of the one or more relay oscillators to be increased by adjusting the adjustable masses or frequencies, wherein increasing the product of mass and frequency squared causes the relay oscillators to be clamped to thermodynamic data of the relay oscillator, wherein said clamping maintains the thermodynamic data of the relay oscillator to be about the same before and after a given thermodynamic evolution;
the oscillators to perform one or more thermodynamic evolutions, wherein the thermodynamic data from a prior thermodynamic evolution evolves to become evolved thermodynamic data;
obtain respective ones of the evolved thermodynamic data, encoded in a position or a momentum degree of freedom of respective ones of the oscillators, wherein the obtained thermodynamic data are Gibbs sampling values for respective ones of the parameters implemented by the oscillators.

2. The system of claim 1, comprising a plurality of block layers of the hierarchical thermodynamic computing architecture to implement a second layer of the hierarchical thermodynamic computing architecture, wherein the plurality of block layers are coupled to each other using the relay oscillators, wherein the relay oscillators comprise:
a first set of relay oscillators;
a second set of relay oscillators; and
a third set of relay oscillators,
wherein:
the first set of relay oscillators provide input for the hierarchical thermodynamic computing architecture;
the second set of relay oscillators obtain output for the hierarchical thermodynamic computing architecture; and
the third set of relay oscillators coupling the plurality of EBMs together represent latent variables for the hierarchical thermodynamic computing architecture.

3. The system of claim 2, wherein respective ones of the pulses cause nested Gibbs sampling to be performed, wherein:
a subset of the oscillators perform the one or more thermodynamic evolutions; and
respective ones of the evolved thermodynamic data are obtained.

4. The system of claim 1, wherein the oscillators comprise:
oscillators configured to obtain input thermodynamic data for the EBM;
oscillators configured to provide output thermodynamic data from the EBM;
oscillators configured to represent neurons of a machine learning model.

5. The system of claim 4, wherein:
the one or more relay oscillators are clamped to the input thermodynamic data and coupled to the oscillators configured to obtain the input thermodynamic data for the EBM; and
the respective ones of the evolved thermodynamic data that are obtained are encoded on the oscillators configured to provide the output thermodynamic data from the EBM.

6. The system of claim 4, wherein the oscillators further comprise:
oscillators, coupled to respective ones of the oscillators configured to represent the neurons, configured to represent synapse values of the machine learning model.

7. The system of claim 6, wherein:
the one or more relay oscillators are clamped to the output thermodynamic data and coupled to the oscillators configured to provide the output thermodynamic data for the EBM; and
the respective ones of the evolved thermodynamic data that are obtained are encoded on the oscillators configured to represent synapse values of the machine learning model.

8. The system of claim 1, wherein the Gibbs sampling values are used to determine gradients used for machine learning model training.

9. The system of claim 1, wherein the Gibbs sampling values are used for machine learning model inference generation.

10. A method, comprising:
implementing one or more energy based models (EBMs) using oscillators, wherein:
the one or more EBMs correspond to respective probability distributions; and
the respective ones of the one or more EBMs implement at least in part a block layer of a hierarchical thermodynamic computing architecture;
initializing respective oscillators of one or more EBMs to thermodynamic data from a prior thermodynamic evolution;
increasing a product of mass and frequency squared of one or more relay oscillators to be increased by adjusting masses or frequencies of the one or more relay oscillators, wherein increasing the product of mass and frequency squared causes the relay oscillators to be clamped to thermodynamic data of the relay oscillator, wherein said clamping maintains the thermodynamic data of the relay oscillator to be about the same before and after a given thermodynamic evolution;
performing one or more thermodynamic evolutions, wherein the thermodynamic data from a prior thermodynamic evolution evolves to become evolved thermodynamic data; and
obtaining thermodynamic data of respective ones of the oscillators, wherein the obtained thermodynamic data corresponds to Gibbs sampling values.

11. The method of claim 10, comprising:
updating respective ones of the oscillators that correspond to parameters of the one or more engineered potentials with the obtained thermodynamic data.

12. The method of claim 11, comprising:
iteratively performing said initializing, thermodynamically evolving, obtaining and updating until the obtained thermodynamic data from the probability distribution implemented by EBMs converges to about a target distribution.

13. The method of claim 10, comprising:
implementing a plurality of block layers of the hierarchical thermodynamic computing architecture to implement a second layer of the hierarchical thermodynamic computing architecture, wherein the plurality of block layers are coupled to each other using relay oscillators.

14. The method of claim 13, comprising:
performing nested Gibbs sampling by:
performing one or more thermodynamic evolutions for a subset of the oscillators; and
obtaining respective ones of the evolved thermodynamic data corresponding to the subset of the oscillators.

15. The method of claim 10, comprising:
clamping one or more relay oscillators to input thermodynamic data; and
coupling the one or more relay oscillators to oscillators configured to obtain the input thermodynamic data for the EBM;
wherein the respective ones of the evolved thermodynamic data that are obtained are encoded on oscillators configured to provide output thermodynamic data from the EBM.

16. The method of claim 10, comprising:
clamping the one or more relay oscillators to output thermodynamic data; and
coupling the one or more relay oscillators are to oscillators configured to provide the output thermodynamic data for the EBM;
wherein the respective ones of the evolved thermodynamic data that are obtained are encoded on oscillators configured to represent synapse values of the machine learning model.

17. The method of claim 10, comprising:
generating inference values for a machine learning model based on the Gibbs sampling values.

18. One or more non-transitory, computer-readable, storage media storing program instructions that, when executed on or across one or more processors, cause the one or more processors to:
implement one or more energy based models (EBMs) using oscillators, wherein:
the one or more EBMs corresponds to respective probability distributions; and
respective ones of the one or more EBMs implement at least in part a block layer of a hierarchical thermodynamic computing architecture;
initialize respective oscillators of one or more EBMs to thermodynamic data from a prior thermodynamic evolution;
increase a product of mass and frequency squared of one or more relay oscillators to be increased by adjusting masses or frequencies of the one or more relay oscillators, wherein increasing the product of mass and frequency squared causes the relay oscillators to be clamped to thermodynamic data of the relay oscillator, wherein said clamping maintains the thermodynamic data of the relay oscillator to be about the same before and after a given thermodynamic evolution;
cause the oscillators to perform one or more thermodynamic evolutions, wherein the thermodynamic data from a prior thermodynamic evolution evolves to become evolved thermodynamic data; and
obtain thermodynamic data of respective ones of the oscillators, wherein the obtained thermodynamic data corresponds to Gibbs sampling values.

19. The one or more non-transitory, computer-readable, storage media of claim 18 that when executed on or across one or more processors, further cause the one or more processors to:
update respective ones of the oscillators that correspond to parameters of the one or more engineered potentials with the obtained thermodynamic data.

20. The one or more non-transitory, computer-readable, storage media of claim 18 that when executed on or across one or more processors, further cause the one or more processors to:
iteratively perform said initialize, thermodynamic evolutions, obtain and update until the obtained thermodynamic data from the probability distribution implemented by EBMs converges to about a target distribution.
